(19) United States
(12) Patent Application Publication
(10) Pub. No.: US 2025/0148335 A1
(43) Pub. Date: May 8, 2025

(54) FREQUENCY PLAN GENERATOR FOR MULTI-QUBIT PROCESSORS

(71) Applicant: International Business Machines Corporation, Armonk, NY (US)

(72) Inventors: Eric Zhang, Sleepy Hollow, NY (US); Jared Barney Hertzberg, Yorktown Heights, NY (US); Jason S. Orcutt, Katonah, NY (US)

(21) Appl. No.: 18/501,113

(22) Filed: Nov. 3, 2023

(51) Int. Cl. G06N 10/40; G06N 10/20; G06N 10/60

(52) U.S. Cl. CPC G06N 10/40; G06N 10/20; G06N 10/60

(57) ABSTRACT

With a computerized frequency plan generator, for each node in a quantum lattice: determine a list of possible frequencies subject to at least one of nearest neighbor and next nearest neighbor collision constraints; and assign a highest possible frequency; apply a collision cleaning routine to the quantum lattice with the assigned frequencies until at least one of a condition where there are no remaining collisions and a condition where collision count ceases to improve; and apply a frequency perturbation routine to the collision-cleaned quantum lattice to move apart at least one of a high-risk nearest neighbor collision and a high risk next nearest neighbor collision.

### BACKGROUND

The present invention relates to the electrical, electronic and computer arts, and more specifically, to computer-aided design of quantum computing systems.

A quantum computer exploits quantum mechanics; i.e., the fact that, at small scales, matter exhibits both particle and wave properties. Quantum computers use qubits, analogous to the bit in conventional digital computing.

Qubits can be realized using many modalities. Some common modalities include superconducting qubits based on circuit quantum electrodynamics (cQED) architectures, trapped ion qubits, spin-based qubits, neutral atoms, or photonic qubits. A common modality is superconducting qubits. Superconducting qubit modalities require cooling to cryogenic temperatures, using a cryostat, a dilution refrigerator, or the like. One pertinent example of a superconducting qubit is the fixed-frequency transmon. Quantum computers operate via quantum logic gates between qubits. Such gates may employ, for example, a microwave-activated coupling, a fast tunable coupling, or a parametric coupling between the qubits that form the gate.

A significant challenge for scaling fixed-frequency architectures is mitigating errors arising from lattice frequency collisions. The LASIQ (Laser Annealing of Stochastically Impaired Qubits) technique has been developed to increase collision-free yield of transmon lattices by selectively trimming (i.e., tuning) individual qubit frequencies via laser thermal annealing. Qubits can be addressed by using unique frequencies; however, undesirable collisions may occur, for example, when the frequencies of two nearest neighbor or next-nearest neighbor qubits become too close, or for example, when the frequency spacing between neighboring qubits are within a similar range as the qubit anharmonicity. Other variations of such frequency collisions may occur, and their precise definition will depend on the type of gates used in the quantum processor. Generally, care should be taken in the assignment of such qubit frequencies to ensure avoidance of frequency collision regions, since frequency crowding is a prevalent and industry-wide issue impacting gate fidelities.

### SUMMARY

Principles of the invention provide techniques for a perturbative deterministic frequency plan generator for multi-qubit processors. In one aspect, an exemplary method (which can be carried out with a computerized frequency plan generator) includes the steps of, for each node in a quantum lattice: determining a list of possible frequencies subject to at least one of nearest neighbor and next nearest neighbor collision constraints; and assigning a highest possible frequency; applying a collision cleaning routine to the quantum lattice with the assigned frequencies until at least one of a condition where there are no remaining collisions and a condition where collision count ceases to improve; and applying a frequency perturbation routine to the collision-cleaned quantum lattice to move apart at least one of a high-risk nearest neighbor collision and a high-risk next nearest neighbor collision.

Optionally, the method further includes, subsequent to application of the collision cleaning routine, and prior to the application of the frequency perturbation routine, carrying out a tuning minimization routine on the quantum lattice to minimize a required tuning distance.

In another aspect, an exemplary computer program product includes a computer readable storage medium having program instructions embodied therewith. The program instructions are executable by a processor to cause the processor to perform a method including: for each node in a quantum lattice: determining a list of possible frequencies subject to at least one of nearest neighbor and next nearest neighbor collision constraints; and assigning a highest possible frequency; applying a collision cleaning routine to the quantum lattice with the assigned frequencies until at least one of a condition where there are no remaining collisions and a condition where collision count ceases to improve; and applying a frequency perturbation routine to the collision-cleaned quantum lattice to move apart at least one of a high-risk nearest neighbor collision and a high-risk next nearest neighbor collision.

In still another aspect, an exemplary apparatus includes: a memory; and at least one processor, coupled to the memory, and operative to: for each node in a quantum lattice: determine a list of possible frequencies subject to at least one of nearest neighbor and next nearest neighbor collision constraints; and assign a highest possible frequency; apply a collision cleaning routine to the quantum lattice with the assigned frequencies until at least one of a condition where there are no remaining collisions and a condition where collision count ceases to improve; and apply a frequency perturbation routine to the collision-cleaned quantum lattice to move apart at least one of a high-risk nearest neighbor collision and a high-risk next nearest neighbor collision.

Optionally, the at least one processor is further operative to facilitate tuning physical qubits in accordance with a frequency tuning plan based on the quantum lattice with the frequency perturbation routine applied.

As used herein, “facilitating” an action includes performing the action, making the action easier, helping to carry the action out, or causing the action to be performed. Thus, by way of example and not limitation, instructions executing on one processor might facilitate an action carried out by instructions executing on a LASIQ tool or a remote processor controlling a LASIQ tool, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improves the technological process of computer-aided design of quantum computing systems, by improving tuning precision and/or tuning accuracy;
improves the technological process of computer-aided design of quantum computing systems, enhancing tuning yield as compared to prior art systems;
improves the performance of quantum computing systems designed in accordance with exemplary embodiments, by improving tuning precision as compared to prior art systems;
improves the technological process of computer-aided design of quantum systems, by improving the speed of frequency tuning plan generation of multi-qubit and/or modular processors;
significant increase in yield of usable processors and/or modular processors. As used herein, “yield” refers to the fraction of quantum processors, of chips within a modular processor, or of qubits within the chip whose frequencies can be set so as to eliminate frequency collisions and/or to minimize gate error. The yield metric may account for frequency shifts or other random changes expected to occur subsequent to the tuning action. These may be assessed statistically using Monte Carlo models or other known methods of probability or statistical modeling. Usability in the context of quantum processors may be understood to mean benefits in terms of gate speed, gate fidelity, low collision count, or any other metric by which the quality of quantum computation may be improved;

Fewer collisions can lead to a reduced time to run a quantum algorithm and the supporting CPU (classical compute and corresponding energy for the calculation); i.e., savings of CPU time for the computer that runs the design algorithms.

These and other features and advantages of the present invention will become apparent from the following detailed description of illustrative embodiments thereof, which is to be read in connection with the accompanying drawings.

### BRIEF DESCRIPTION OF THE DRAWINGS

FIGS. 1 and 2 respectively show collision definitions for a gate error of 1.0% and for a gate error of 0.5%, according to aspects of the invention;

FIG. 3 shows seven collision types, according to aspects of the invention;

FIG. 4 depicts an example of a single 65-qubit ‘heavy hexagon’ lattice undergoing tuning, according to aspects of the invention;

FIGS. 5 and 6 respectively show frequency versus qubit number and collisions versus iteration for the ‘heavy hexagon’ example of FIG. 4;

FIG. 7 depicts an example of a single 127-qubit ‘heavy hexagon’ lattice undergoing tuning, according to aspects of the invention;

FIGS. 8 and 9 respectively show frequency versus qubit number and collisions versus iteration for the ‘heavy hexagon’ example of FIG. 7;

FIG. 10 depicts a high-level tuning plan procedure, according to aspects of the invention;

FIG. 11 shows tuning examples on a 27 qubit lattice, according to aspects of the invention;

FIG. 12 is a table showing exemplary tuning plan performance for a 27 qubit system, according to aspects of the invention;

FIG. 13 depicts aspects of tuning plan initialization, according to aspects of the invention;

FIG. 14 depicts details of an exemplary tuning plan algorithm, in accordance with aspects of the invention;

FIG. 15 provides additional description of the exemplary tuning plan algorithm, in accordance with aspects of the invention;

FIGS. 16 and 17 depict an exemplary lattice stepping routine, in accordance with aspects of the invention;

FIG. 18 is a collision cleaning routine, in accordance with aspects of the invention;

FIG. 19 depicts a tuning minimization routine, in accordance with aspects of the invention;

FIG. 20 is an exemplary frequency perturbation routine, in accordance with aspects of the invention;

FIG. 21 shows example results of the frequency perturbation routine, in accordance with aspects of the invention;

FIG. 22 depicts a regularly-spaced rendering of single 127-qubit ‘heavy hexagon’ fixed-frequency transmon qubit lattice for an exemplary chip that can be tuned in accordance with aspects of the invention;

FIG. 23 depicts a regularly-spaced rendering of single 65-qubit ‘heavy hexagon’ fixed-frequency transmon qubit lattice for an exemplary chip that can be tuned in accordance with aspects of the invention;

FIG. 24 depicts a regularly-spaced rendering of single 27-qubit ‘heavy hexagon’ fixed-frequency transmon qubit lattice for an exemplary chip that can be tuned in accordance with aspects of the invention;

FIG. 25 depicts aspects of tuning plan generation, in accordance with an exemplary embodiment;

FIG. 26 shows aspects of tuning of modular devices and non-cross-resonance devices, in accordance with aspects of the invention;

FIG. 27 depicts a coupling manifold, in accordance with aspects of the invention;

FIG. 28 shows aspects related to using the perturbative and deterministic process to satisfy some of the requirements of tuning of modular devices, in accordance with aspects of the invention;

FIG. 29 depicts a generalization for the tuning plan for a multi-qubit chip with flux-tunable elements (e.g., tunable couplers), for both deterministic and perturbative aspects, in accordance with an exemplary embodiment;

FIG. 30 shows aspects of tuning plan generation and tuning flow, in accordance with an exemplary embodiment;

FIG. 31 depicts aspects of iterative tuning rounds, in accordance with an exemplary embodiment;

FIG. 32 shows aspects of yield assessment, in accordance with an exemplary embodiment; and

FIG. 33 depicts a computing environment according to an embodiment of the present invention.

### DETAILED DESCRIPTION

LASIQ tuning is a process of progressive alteration of the resistances of Josephson junctions. To this end, any quantum element including one or more Josephson junctions may be tuned using LASIQ. For example, a fixed-frequency transmon qubit includes a Josephson junction shunted by a capacitor, whereby the Josephson junction behaves as a nonlinear inductor element that allows the qubit to exhibit non-uniform energy spacing between successive energy levels (i.e., the qubit exhibits anharmonicity which allows uniquely addressable ground and first excited states). By performing LASIQ on these fixed-frequency transmon qubits, the Josephson junction resistances, and correspondingly the transmon qubit frequencies, may be modified post-fabrication. In this context, LASIQ may therefore be used as a post-fabrication frequency trimming tool to engineer qubit frequencies to desired frequency patterns.

Lattices of fixed-frequency transmon qubits are typically fabricated in a specific lattice geometry (for example, a heavy-hexagonal lattice, square lattice, or the like). Furthermore, qubits are known to suffer from frequency crowding, which arises from energy level degeneracies between neighboring and next-nearest-neighboring qubits, and even higher order connectivity may be considered. This frequency crowding may be quantified by the number of collisions that the multi-qubit lattice exhibits. Each collision type may be defined by frequency bounds within which qubit pairs, or triplets are forbidden to enter. Other undesired neighboring, next-nearest neighboring, or further neighboring interactions may be enumerated and frequency bounds may be similarly defined as desired. If these bounds are trespassed, high gate errors, and therefore low gate fidelities will be observed. LASIQ is a laser-annealing methodology that may be used to iteratively tune the Josephson junction resistances using a sequence of annealing ‘pulses,’ to gradually and monotonically approach their respective target resistances, thereby engineering the qubit frequencies into desired values, levels, patterns, or the like.

The term ‘pulse’ as used herein denotes a laser anneal operation that is performed by applying laser power to a target element (e.g., Josephson junction) for a specified duration (anneal time) to tune the target element. In the context of exemplary embodiments of the disclosure as discussed herein, laser tuning methods are provided to tune junction resistances of Josephson junctions in a progressive and incremental manner wherein multiple ‘pulses’ are applied to a given Josephson junction to tune the junction resistance of the Josephson junction to a target junction resistance.

The term “annealing iteration” used herein and in the context of a laser annealing process is meant to refer to the process which comprises a single laser pulse along with associated control, measurement and computation by the LASIQ computer system and apparatus to determine the necessary anneal time and power for the anneal pulse. A laser annealing iteration, or LASIQ iteration, therefore, refers to the entire process by which a Josephson junction is measured, the anneal power and time is determined, and the anneal pulse is performed. In this sense, one iteration involves the entire sequence of the laser annealing system and apparatus as it pertains to one step of the progressive approach to the resistance target for one Josephson junction. The tuning of one junction to completion (i.e., reaching its resistance target) may therefore be said to progress “iteratively.” The term “iterative process” as used herein, is meant to generally refer to a set of iterations, as applicable to one or more qubit devices, or the like, including Josephson junctions, whereby the one or more qubit devices are tuned with the purpose of approaching their respective targets.

The term ‘round-robin’ or ‘annealing round’ as used herein and in the context of a laser annealing process, is meant to refer to a tuning process in which all qubits on a multi-qubit device undergo the laser annealing process in succession, and which may be followed by another round-robin or multiple round-robins in succession. Such round-robins may be continuously performed until all qubits on the multi-qubit device reach their respective targets. For example, a singulated quantum chip may include a number of qubit devices (e.g., 100 qubits, denoted Q1, Q2, Q3, . . . , Q100) including Josephson junctions. In an exemplary embodiment of a tuning method, Q1 will first be tuned with one or more annealing iterations, as desired. The process will proceed to Q2, where one or more annealing iterations may be performed, as desired. The process will then proceed to Q3, etc. until finally Q100 is tuned with one or more annealing iterations, as desired. This entire process from Q1 to Q100 is defined as one round-robin. After this first round-robin, the process may return to Q1, and will repeat again until Q100 is reached. The process of successive round-robins may provide time control and delay between iterations or sets of iterations, such that the Josephson junctions may be permitted to relax to their final resistances prior to the next annealing iteration or set of iterations.

During LASIQ tuning, the frequencies typically monotonically and iteratively approach the target, where the resistance targets, or equivalently, frequency targets are determined through a frequency tuning plan generator. The iterative approach to target is based on successive laser ‘pulses’ that asymptotically move the qubit frequencies to a target frequency. The asymptotic and gradual tuning approach reduces the risk of overshooting or undershooting the junction resistances. To ensure this progressive approach to target, various calibration structures may be utilized towards determining the typical tuning rate and tuning range of the Josephson junctions, using dedicated test structures that may be interleaved and/or situated on unused locations of the chip (for example, the ‘kerf’ of a chip, which is an unused location that physically separates two adjacent dies on a wafer, or coupon), or using a ‘sister’ chip, which has undergone the same process steps during fabrication. However, despite the care taken to avoid overshooting or undershooting, the statistical likelihood of such anomalies increases and is practically unavoidable as quantum chips scale to the hundreds, or thousands of qubit scales and greater. In other words, given the large scales of modern quantum processors, it is essentially impossible for all qubits to successfully achieve their target frequencies as designed in an initial tuning plan. This is detrimental to chip yield (for example, as assessed by the collision-free probability), which results in the chip being discarded (e.g., due to the anticipated high gate-error rates). The net effect involves significant reduction in the resulting number of usable processors, given a batch of chips that are to be tuned. One or more embodiments provide techniques for in-situ and adaptive target modification to be able to correct for these tuning errors and imperfections to increase the yield of quantum processors.

Yield metrics of quantum processor(s) may be assessed through both deterministic and statistical analysis, or the like. For example, one yield metric commonly used may include the number of collisions in an as-tuned chip, or a comparison of collision numbers before and after LASIQ tuning. However, more sophisticated methods may be implemented to determine the expected number of collisions that may be obtained after completion and cooling of a quantum processor in a cryostat. Such methods apply to single-chip processors and both within and across each chip of a modular device. This may be accomplished, for example, using a Monte Carlo method, or the like, by which the predicted frequencies undergo a random scatter with a magnitude defined by a frequency precision interval (e.g., 20 MHz), and the impact of the scatter of the expected number of collisions is quantitatively assessed. Equivalently, it is possible to calculate the expected probability of a zero-collision chip on a non-modular or modular device. Another metric that may be used is predictions of gate error rates, gate fidelity, and/or gate speed. Such models may take into account, for example, qubit coherence times in addition to qubit frequencies after LASIQ tuning. Such models are architecture dependent. However, one or more embodiments for adaptive and in-situ modifications of such tuning plans are not limited to any specific architecture, but rather, given a known architecture of lattices and qubit coupling mechanisms and acceptable yield metrics, one or more embodiments may be implemented to generally and significantly improve the fraction of acceptable chips. Once a multi-qubit chip has been successfully tuned, such yield metrics may be employed to select the desired candidate for further cryogenic screening, whereby the multi-qubit processor may be cooled to cryogenic temperatures and further characterized, for example, by measuring the qubit frequencies and comparing them to predicted frequency targets, quantifying qubit coherence, measuring single and multi-qubit gate fidelities, and the like.

As noted above, the LASIQ (Laser Annealing of Stochastically Impaired Qubits) technique has been developed to increase collision-free yield of transmon lattices by selectively trimming (i.e., tuning) individual qubit frequencies via laser thermal annealing. LASIQ tuning can be used in one or more exemplary embodiments. However, it is to be understood that embodiments described herein requiring frequency tuning (e.g., of functional qubits, quantum logic structures, quantum coupling structures, or any general elements that include one or more Josephson junctions) are not limited solely to the use of LASIQ tuning, but rather, any frequency tuning capability of qubits and/or elements based on Josephson junctions may be utilized to satisfy the frequency tuning requirements needed to successfully implement a quantum device including one or more interconnected processors, as may occur in a modular device (i.e., various embodiments are applicable to both modular and non-modular systems). In one exemplary embodiment, a LASIQ tool is used to perform laser-annealing of Josephson junctions of fixed-frequency transmon qubits, which are connected in a heavy-hexagonal lattice, whereby nearest and next-nearest neighboring collisions are considered.

Tunable superconducting qubit architectures can be employed in some instances. In one or more embodiments, significant gain in yield may be obtained using techniques to selectively trim frequencies of individual qubits and various elements based on Josephson junctions, that may be part of tunable superconducting qubit architectures.

Frequency tunability via laser annealing (e.g., the LASIQ process) may be assessed, for example, using the calibration methodology described elsewhere herein, by which a set of trial junctions are laser-annealed to determine the tuning rate and tuning range, and any other functional parameter deemed necessary to tune junctions to completion. In particular, in one or more embodiments, tuning rates are used to estimate the laser annealing duration required to substantially tune a junction to completion, and the tuning range (i.e., maximum tuning limit) is used to constrain the generation of the tuning plan for qubit frequencies (as used herein, “substantially tune a junction to completion” means the tuning needed to tune a junction to a target completion band, which could be, in a non-limiting example as discussed elsewhere herein, 0.3% of the target resistance. The 0.3% figure is exemplary and can be modified as needed by the skilled artisan based on heuristics depending on the domain of interest and application). As an example, a tuning plan may include a fixed multitude of frequency levels, and each qubit should reside on one of these levels, and also be tunable to these levels. The latter condition is determined by calibration of similar junctions, whereby these similar junctions are tuned to observe how far their resistances may be shifted. By appropriate assignment of each qubit to a frequency level, and within tunability constraints, it is possible to avoid level degeneracies that may cause unwanted crosstalk (i.e., collisions) and therefore low gate fidelity. Other examples of methods by which a tuning plan is generated can include a fixed frequency plan, or an optimization protocol by which each qubit may reside within a range of frequencies, whereby this range (constrained by collision bounds) is subject to the frequency value of neighboring or next-nearest neighboring qubits. The mentioned exemplary methods for generating tuning plans are not intended to be exhaustive, but rather serve as illustrative examples of methods by which tuning plans can be generated given a lattice topology, as is the case in lattices of superconducting qubits. In general, any other tuning plan generators which adequately mitigate frequency collisions would be considered acceptable, as will be apparent to the skilled artisan given the teachings herein. Such tuning plans outside the scope of fixed-frequency patterns and optimization protocols are referred to herein as “ad-hoc” plans. Described herein is a set of methods to automate the generation of a class of ad-hoc plans based on fixed-frequency levels, and further increase the margin of separation from collision bounds by perturbing the qubit frequencies in the tuning plan to minimize the probability of collisions after LASIQ tuning. The former will herein be referred as a “deterministic” plan generator, in reference to an identical output for identical input frequency and constraint parameters. The latter will be referred as a “perturbative” plan generator, by separating the qubits and increasing the margins from the collision bounds to probabilistically mitigate the number of resulting collisions in the tuning plan. Both the deterministic and perturbative plan generators may be implemented on a new chip which has not been previously tuned, or on an already tuned chip, where new targets must be generated; for example, in the case where tuning imperfections are such that the tuning plan needs to be corrected to avoid low tuning yield. The latter will involve “adaptive” tuning plans whereby the yield of the chip may be assessed in situ during the tuning and corrections to the tuning plan may be made accordingly. However, the adaptive methods described herein are not limited by any specific method of tuning plan generation, but may be generally applicable to any frequency tuning plan generator, whether ad-hoc, or the like.

Frequency collision analysis and collision-free yield may be an important metric to consider when determining the yield of a tuned chip. Collision bounds for a given quantum processor architecture may be derived using known empirical and/or first-principles gate error models for the superconducting qubit architecture being tuned. As an illustrative embodiment, a fixed-frequency transmon qubit pair can be modeled as undergoing ZX interaction which is used to realize a CNOT (controlled NOT) gate. High-fidelity gates typically require this interaction to be controlled by assigning appropriate bounds to the relative frequency difference between nearest- and next-nearest neighboring transmon qubits pairs. Gate error modeling should therefore account for this interaction while accounting for various sources of noise; for example, that arising from static ZZ interactions among qubits. In one or more exemplary methods, the gate error modeling, and therefore frequency collision bounds, may be performed by empirically measuring the frequencies of devices and the corresponding gate fidelities that may be achieved on the given architecture.

The skilled artisan, given the teachings herein, can adapt known tuning plan generators to implement one or more embodiments. Nominally, junction resistances increase, and therefore qubit frequencies decrease upon tuning. Therefore, for example, if a qubit or group of qubits undershot in resistance (i.e. reached their tuning limits before they could reach target), one or more embodiments generate a new tuning plan subject to the constraint that the undershot qubits should not be moved any more, since there is no more tuning range left in those qubits. On the other hand, if, for example, a qubit or group of qubits overshot, one or more embodiments generate a plan that allows them to continue tuning if they have not yet reached their estimated maximum range. In some embodiments, qubits tune bi-directionally. In this aspect, they can be tuned both up and down as needed, within the tuning range limits. The nature and directionality of tuning may be determined based on the calibration trial junctions, which will be subjected to laser annealing at various combination of laser power and time.

It is currently envisioned that a future quantum computer (>1000 qubits in the Condor processor), utilizing cross-resonance technology from International Business Machines Corporation (IBM), Armonk, NY, USA, will make use of fixed-frequency transmon qubits, which require post-fabrication frequency trimming using LASIQ. We have found, using modeling, collision zones that should be avoided to ensure high gate fidelity (7 collision types), and that, ideally, fixed frequency patterns (e.g., 3 frequency (3f) patterns) will help to effectively avoid all collision types. As fabricated, there may be a large initial tuning spread on the qubits (up to 5% in resistance, which corresponds to up to 200 MHZ (megahertz) in frequency spread). With such a large spread, it is not feasible to control the number of collisions in an as-fabricated multi-qubit processor. The LASIQ process can be used to control this to a frequency precision of about 20 MHz, providing an order of magnitude improvement in frequency control. However, due to limited tuning range (˜15% in resistance) and initial tuning spread (up to ˜5% resistance), it is generally not possible to attain an ideal 3f pattern using current laser annealing techniques. One or more embodiments described herein mitigate frequency crowding. One or more embodiments advantageously provide an alternative frequency plan generator that can work within the constraints of tuning range and collision boundaries to generate an adequate tuning plan for a given processor before it enters the LASIQ process. Such constraints may, for example, include tuning range limits such that the alternative frequency plans may satisfy yield requirements.

It is worth noting that one or more embodiments are specifically directed to cross-resonance devices; however, tuning plans could also be implemented for modular devices and different architectures that include tunable elements. In general, both the deterministic and perturbative plans described herein may be implemented on a quantum processor of any connectivity and architecture, provided that operating frequencies, frequency avoidance regimes (i.e., collision bounds) of the individual elements, whether they be functional qubits, quantum logic structures, quantum coupling structures, or any general elements that include one or more Josephson junctions, are provided as parametrized inputs to the tuning plan generator.

One or more embodiments provide techniques for a deterministic tuning routine that removes frequency collisions by assigning appropriate frequencies to qubits one after another, based on fixed frequency levels (i.e., based not on fixed frequency patterns but on fixed frequency levels). Qubits can be appropriately assigned into the levels. In some embodiments, a minimum tuning solution can be implemented, which checks whether less tuning can be performed while still maintaining collision counts. Some instances provide a collision cleaning routine which allows collision swapping and intermediate level spacing to reduce the total collision count. In this context, collision swapping is referred to the process of permitting the reassignment of qubit frequencies such that the total number of collision does not increase (they may, for example, remain the same), but the number of collisions for each collision type may vary. One or more embodiments provide a collision cleaning routine which allows collision swapping and intermediate level spacing to reduce the total collision count. In some embodiments, the tuning plan generator can be used for tunable multi-qubit architectures. Thus, in one or more embodiments, a minimum tuning solution goes through a proposed solution and checks whether less tuning can be applied to any particular qubit without increasing the number of collisions; a collision cleaning routine cleans out any residual collisions; and a frequency perturbation routine perturbs the frequency pairs in a fixed-level plan (the deterministic aspect) to minimize the probability of collisions in the yield analysis.

We have conducted both experiments and simulations demonstrating the tuning plan efficacy, in both speed of operation and mitigation of collisions, to allow tuning of systems with, for example, 27 qubits (“27Q”) (e.g., IBM's Falcon 27 qubit system), 65 qubits (“65Q”) (e.g., IBM's Hummingbird 65 qubit system), and/or 127 qubits (“127Q”) (e.g., IBM's Eagle 127 qubit system).

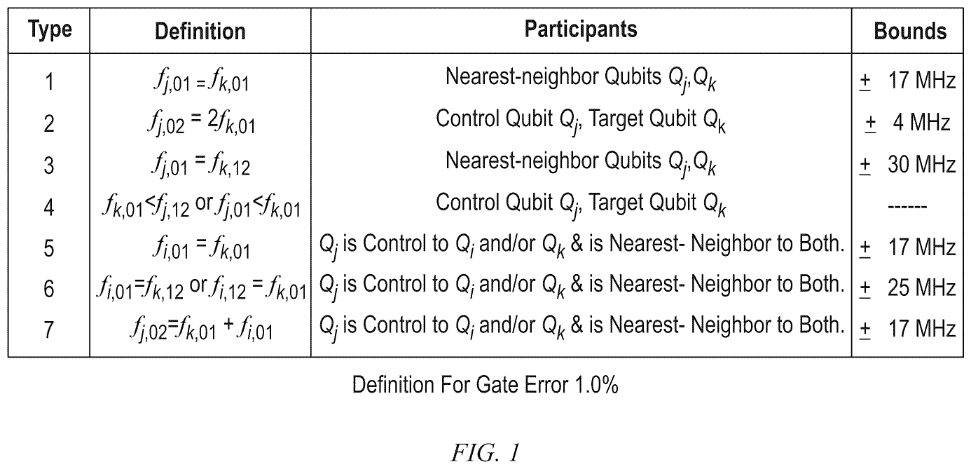

Referring now to FIGS. 1 and 2, in one or more embodiments, constraints include avoiding all 7 frequency collision types. Generally, frequency collision types and bounds will now be considered. We have found that in one or more embodiments, there are 7 types of collisions, with the definition depending on the target gate error. The table of FIG. 1 shows the definition for a gate error of 1.0%. The table of FIG. 2 shows the definition for a gate error of 0.5%.

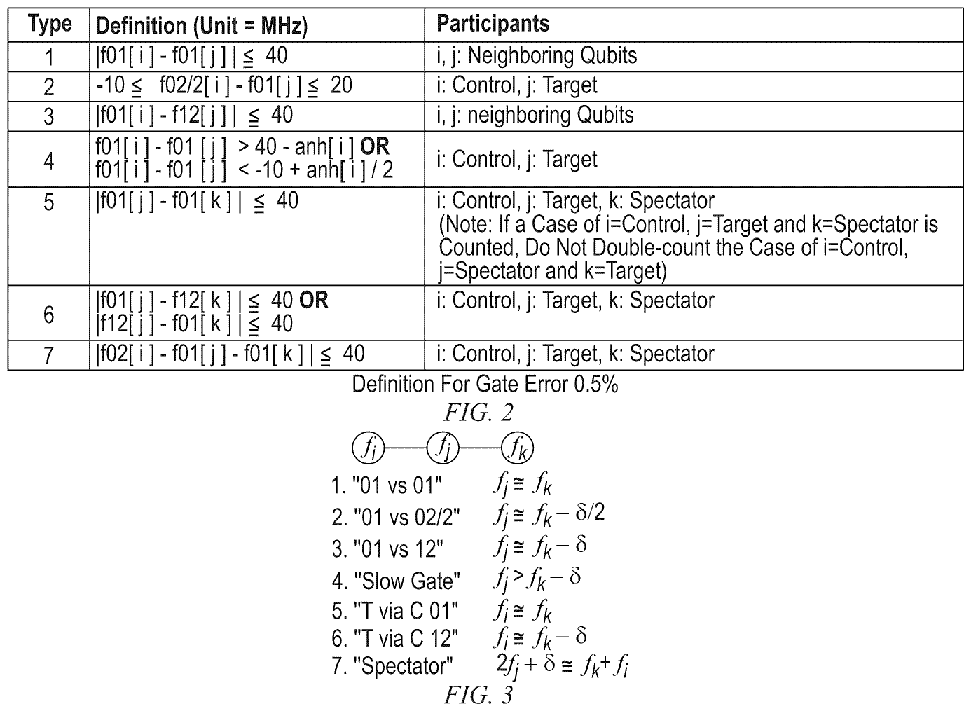

FIG. 3 shows the seven collision types, including nearest neighbor and spectator. Under nominal conditions, assume a control frequency greater than the target frequency f_{01,i}>f_{01,j}. However, other orientations may be used. In the example, all the qubits (transmons) have an anharmonicity, δ, of approximately −300 MHz. As depicted in FIG. 3, type-1 collisions result from a direct hybridization of the i and j qubits. Type-2 and 3 collisions excite control or target qubits into the non-computational |2> state, while type-4 collisions are a consequence of excess detuning such that the ZX interaction is weak resulting in a ‘slow gate’. Collision types-5 through 7 result in unwanted next-nearest-neighbor interactions which may in turn excite unwanted higher-level non-computational states. In general, it is desired to eliminate as many collisions as possible to maximize the fidelity of quantum gate operations.

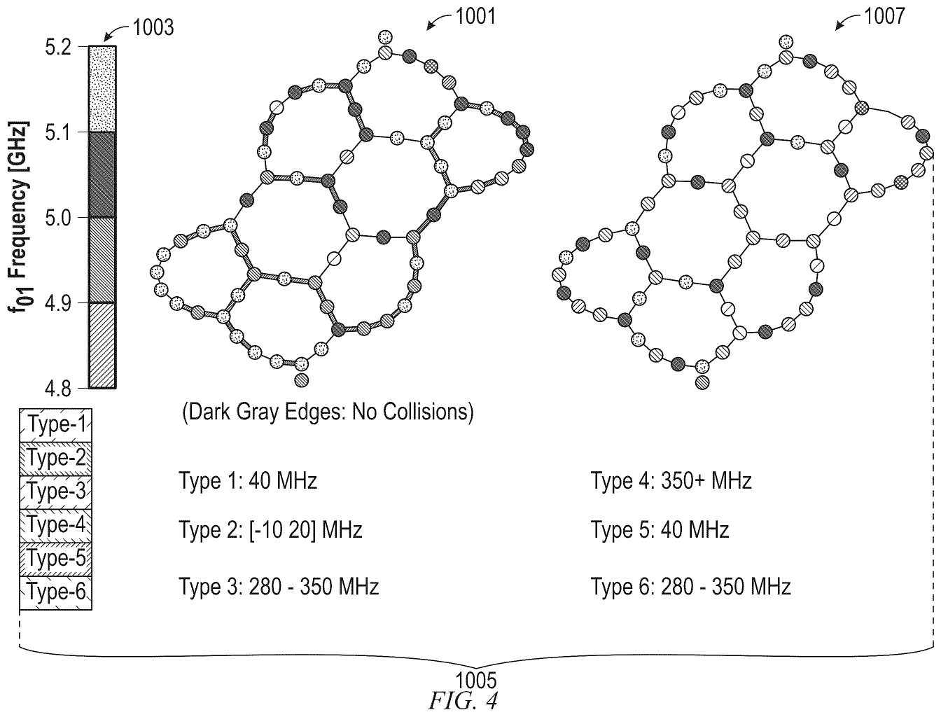

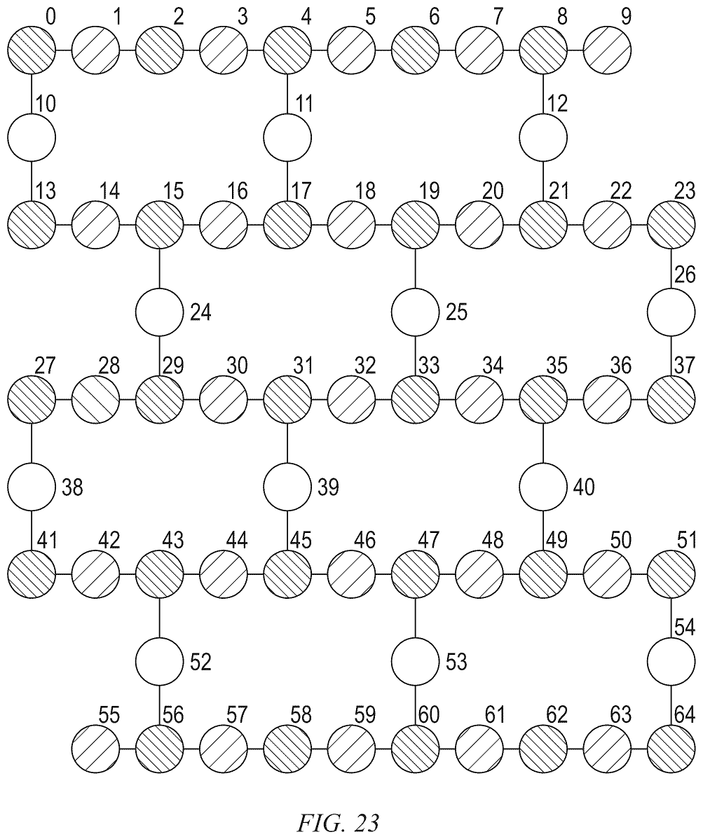

FIG. 4 depicts an example of a single 65-qubit ‘heavy hexagon’ lattice (e.g., IBM's Hummingbird 65 qubit system) undergoing tuning. Note that the non-regular lattice spacing in FIG. 4 is unrelated to the tuning behavior, but results from the aspect ratio of the rendering. FIG. 23 shows a regularly-spaced rendering of such a lattice. View 1001 shows the initial (as-fabricated) predicted qubit frequencies, with node frequencies indicated by the legend 1003. It can be seen that the frequencies are on the high end of an acceptable range, which may, for example, result from the Purcell filtering band. The edges between nodes are coded according to the collision type (legend 1005). Type 7 collisions were ignored in this example. As an aside, regarding topology, various topologies can be used such as heavy-hexagonal lattice, square lattice, and the like. In general, lower average degree connectivity lattices have reduced risk of frequency collisions (due to their lower connectivity), but at the expense of an overhead for quantum computation (e.g., in the case of implementing error correcting codes). The exact topology may be selected based on the application needs of the system. View 1007 indicates the final frequency distribution pattern after the tuning plan generator has completed, with reference to legends 1003, 1005.

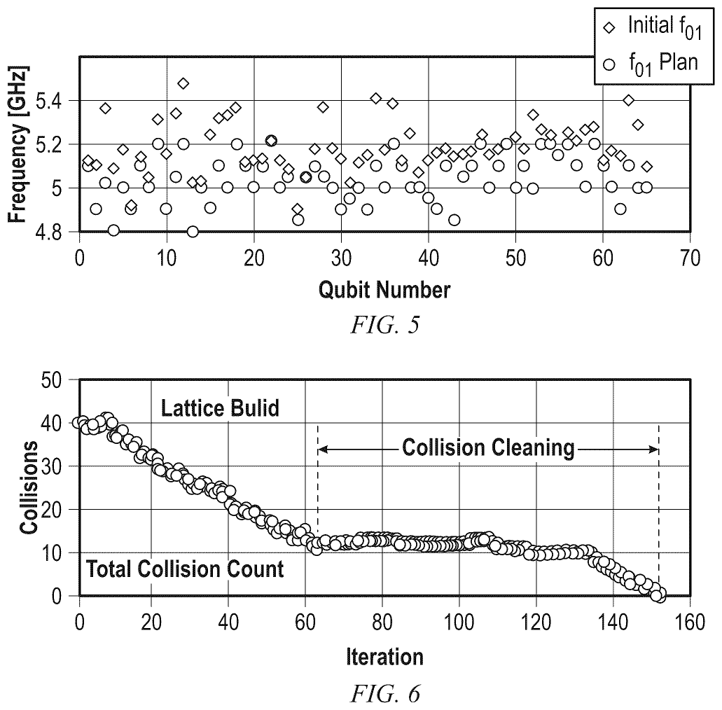

In one or more embodiments, as part of the frequency plan generators, it is possible to pick and choose which collision types it is desired to avoid. For example, it may be desired to just avoid nearest neighbor collisions (Types 1, 2, 3, and 4); or sometimes to just avoid next nearest neighbors collisions (Types 5, 6, and 7). In some situations, there may be less concern with Type 7 collisions as opposed to Types 1-6. In general, the skilled artisan may use a subset or superset of collisions and bounds shown in FIGS. 1-3 as desired, and the relevant collisions prioritized as needed. Prioritization may, for example, occur by assigning suitable bounds to a collision type. To entirely ignore a collision, one may for example set the collision bound(s) to be null. FIG. 5 shows the initial frequency distribution in diamond data points, and the final frequency plan from the generator is in round data points. The aspect illustrated with regard to FIG. 5 is purely based on the deterministic plan generator; it does not yet incorporate the perturbative aspect. It can be seen that the round data points occupy more or less fixed frequency levels; that is, they are arranged into a multitude of fixed frequency levels and each qubit is assigned based on constraints of tuning range, collisions, and any other constraints a skilled artisan may provide. There is not so much a pattern, but rather, there is a set of levels, and sometimes half levels are allowed. Qubit frequencies can be placed into each one of the levels as needed. In one or more embodiments, start the process by walking through the lattice, and assigning a frequency to each one of the qubits, based on allowable frequency levels, where the selected frequency level for the qubit does not create a collision or creates a minimum of collisions. This “walk” is carried out over the entire lattice. Once complete, a certain number of residual collisions may be found, for example, ten (see FIG. 6 around iteration number 60). A collision cleaning routine can be applied as indicated, to bring the collision count down to zero (past iteration 150). In one or more embodiments, a further perturbation routine is applied to minimize the probability of new collisions by maximizing the margin to collision bounds, with the goal of minimizing the probability that collisions may appear in the presence of random scatter, either due to imperfect tuning yield or scatter once the quantum processor is cooled and measured in a cryostat. In connection with FIGS. 4-6, note 13% maximum resistance tuning and 100 MHz level spacing (50 MHz 1/2 level spacing), which serves as a representative example of tuning range and selected level spacing for assigning fixed frequency levels.

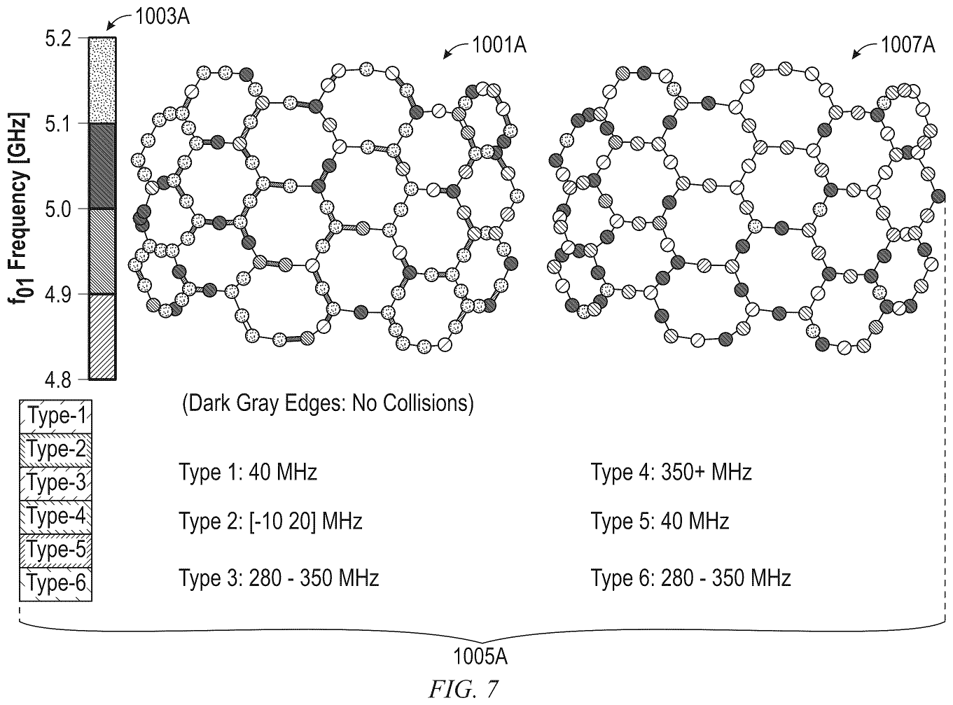

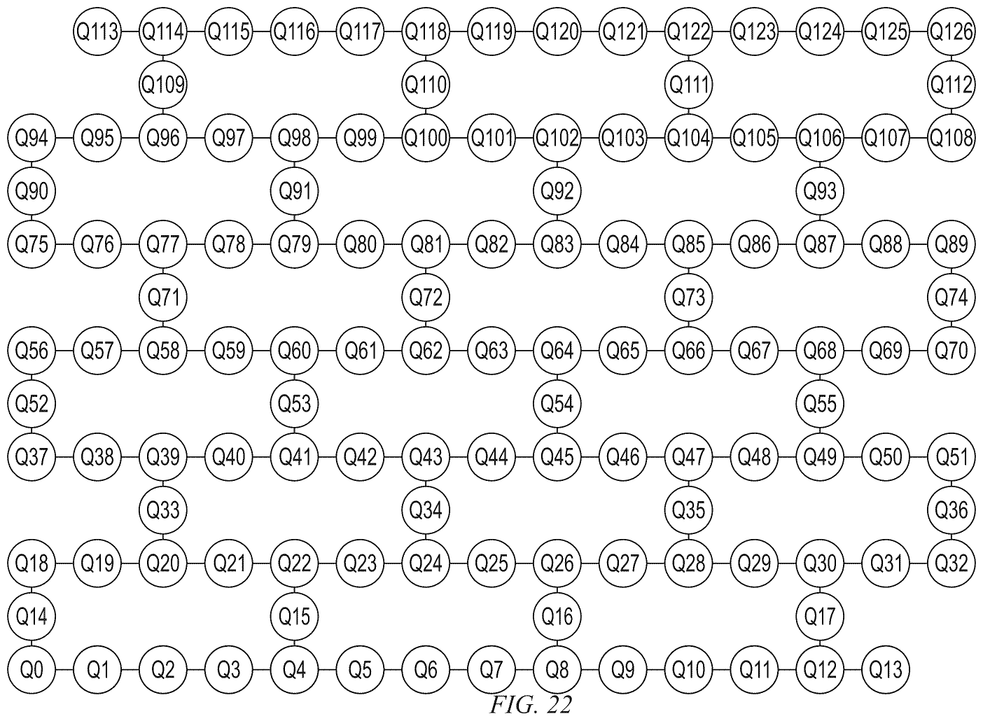

FIG. 7 depicts an example of a single 127-qubit ‘heavy hexagon’ lattice (e.g., IBM's Eagle 127 qubit system) undergoing tuning. Note that the non-regular lattice spacing in FIG. 7 is unrelated to the tuning behavior, but results from the aspect ratio of the rendering. FIG. 22 shows a regularly-spaced rendering of such a lattice. View 1001A shows the initial (as-fabricated) predicted qubit frequencies, with node frequencies indicated by the legend 1003A. It can be seen that the frequencies are on the high end, with many at or beyond 5.2 GHz. The edges between nodes are coded according to the collision type (legend 1005A). Type 7 collisions were, as before, ignored in this example. View 1007A indicates the final frequency distribution pattern after the tuning plan generator has completed, with reference to legends 1003A, 1005A.

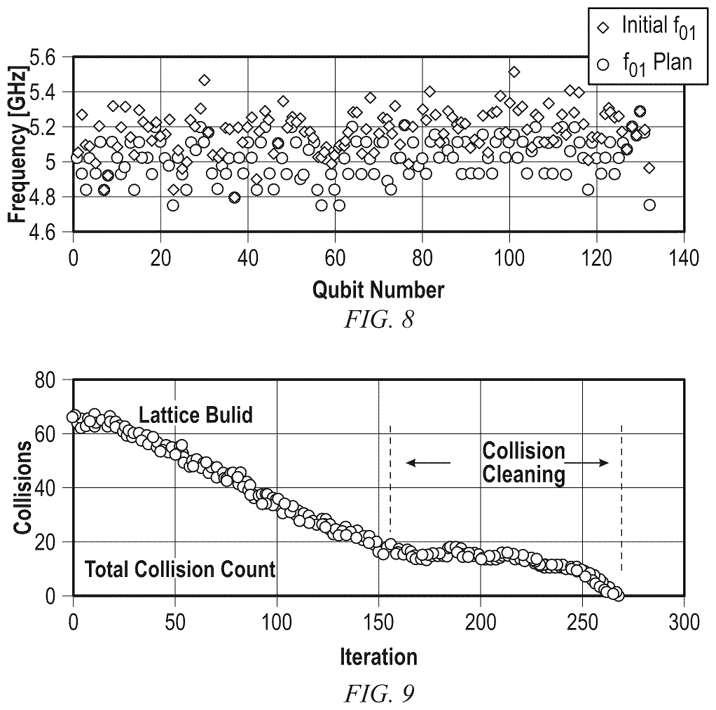

FIG. 8, similar to FIG. 5, shows the initial frequency distribution in diamond data points, and the final frequency plan from the generator is in round data points. Here as well, once complete, a certain number of residual collisions may be found after the initial phase of the deterministic frequency assignment, for example, slightly less than 20 (see FIG. 9 around iteration number 150). A collision cleaning routine can be applied as indicated, to bring the collision count down to zero (past iteration 250). In connection with FIGS. 7-9, note 14% maximum resistance tuning (5.98% median), 90 MHz level spacing (45 MHz 1/2 level spacing), and 126 out of 127 qubits tuned.

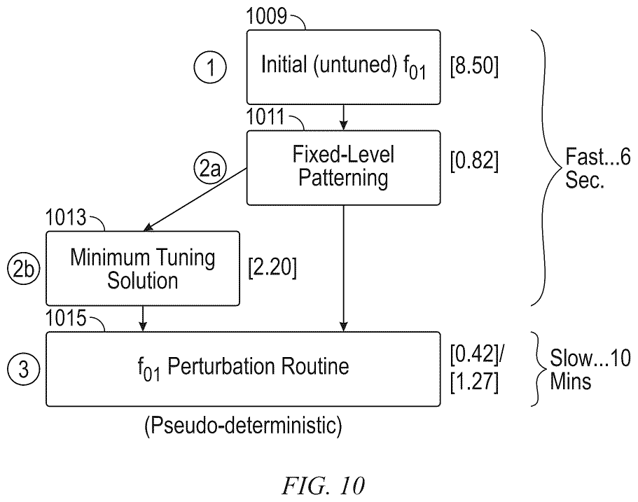

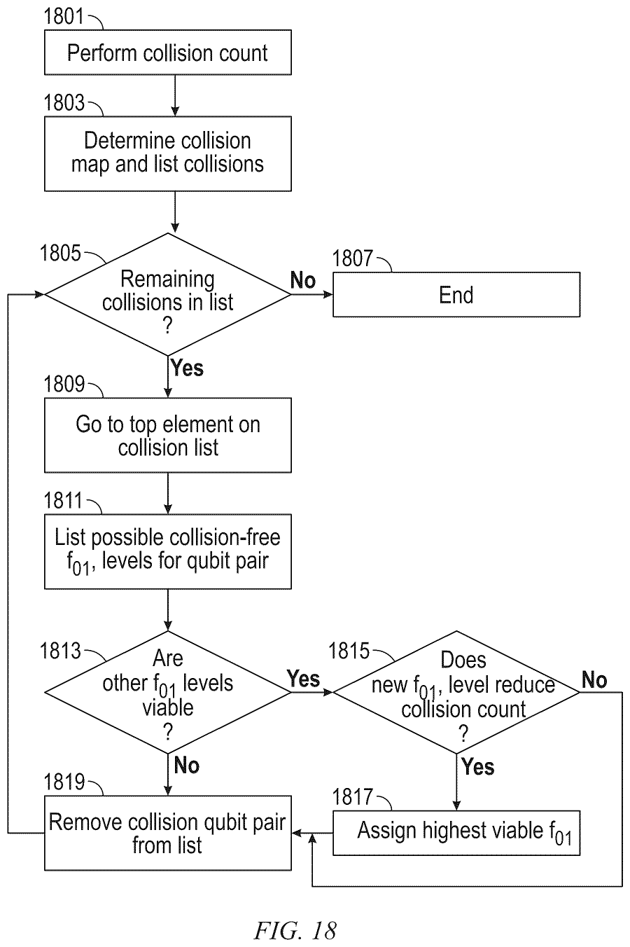

FIG. 10 depicts a tuning plan high-level procedure. As noted at 1009, there are some initial frequencies. Step 1011 “2a” includes fixed frequency patterning, which includes both the initial frequency assignment as well as the collision cleaning routine (FIG. 18). Step through the lattice, and assign the maximum available for. Carry out ‘collision cleaning’ and enable collision swapping.

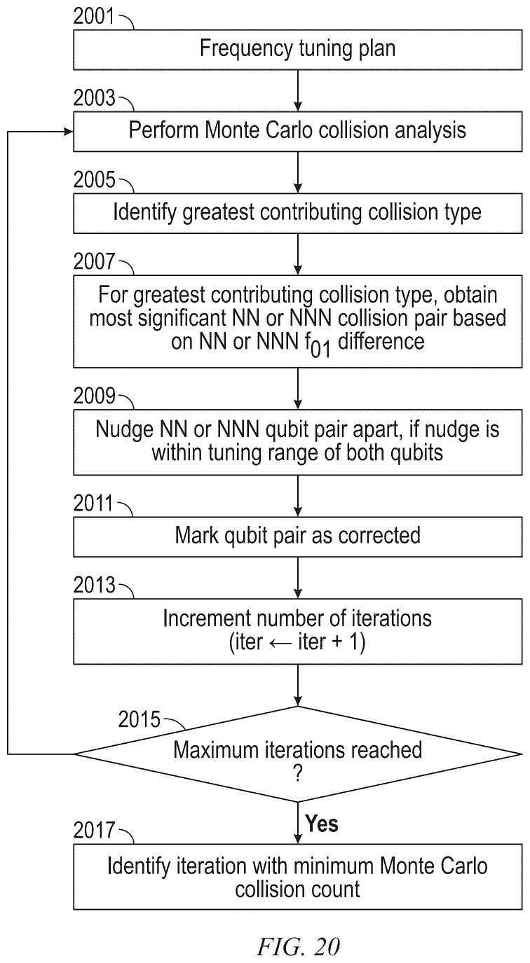

Optionally, a minimum tuning solution “2b” can be applied in step 1013. In this aspect, iterate over the lattice, assign the maximum available for which maintains the collision count, and permits 1/2-level spacing. Alternatively, proceed directly to step 1015 for perturbation routine “3” which is a pseudo-deterministic perturbation routine. In step 1015, the frequency perturbation routine is performed, broadly defined by a three-step process, also detailed in FIG. 20. In the first step, a Monte Carlo assessment provides the greatest contributing collision type. Based on the greatest contributing collision type, a ranked list of collision-pairs or triplets is created, based on the likelihood of yielding a collision of that type. The qubit pair or triplet is subsequently ‘perturbed’ by a selected amount, for example, 5 MHZ, and the Monte Carlo assessment is repeated to assess the resulting collisions. By repeating this over many iterations, the high-likelihood collisions are mitigated, thus increasing the functional yield of the quantum processor.

The overall sequence in FIG. 10, including both the deterministic and perturbative tuning plan generators, has been performed on a 27-qubit ‘heavy hexagon’ lattice (e.g., IBM's Falcon 27 qubit system), with the Monte Carlo predicted total collisions depicted on the right side of each tuning plan stage. In this example, type-1 through 5 collisions were considered, while type-6 and 7 collisions have been ignored. However, depending on the application, a subset or superset of the type-1 through 7 collision may be implemented depending on the particular needs of the quantum processor in question. Note the reduction in collisions from 8.5 to 0.82 to 0.42 when proceeding directly from step 1011 “2a” to step “3.” When applying the minimum tuning solution of step 1013, an attempt is made to minimize the amount of tuning. This brings the collision count back up slightly to 2.2. Thus, step 1013 minimizes the required tuning distance at the expense of collisions. However, the separation or perturbation routine of step 1015 brings the number of collisions back down again to 1.27. The values 8.50, 0.82, 2.20, and 0.42/1.27 correspond to the expected number of collisions, based on Monte Carlo analysis, for the frequency assignments that are in each stage (these exemplary results are for IBM's Falcon 27-qubit system). It can be seen for the 27-qubit system, that the collision count is substantially reduced after the fixed level patterning 1011; however, similar improvements are found for larger multi-qubit systems.

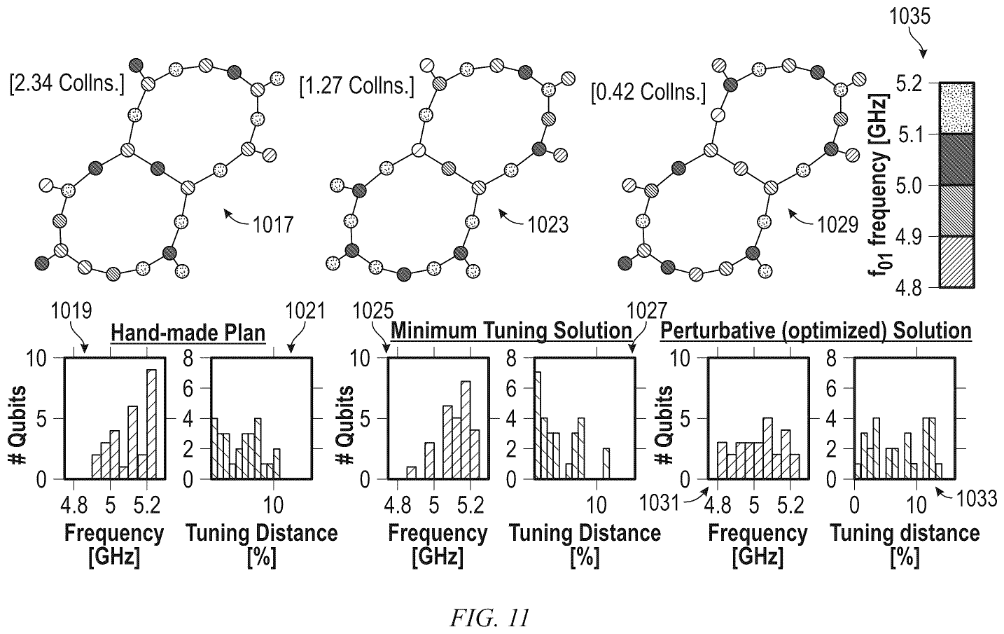

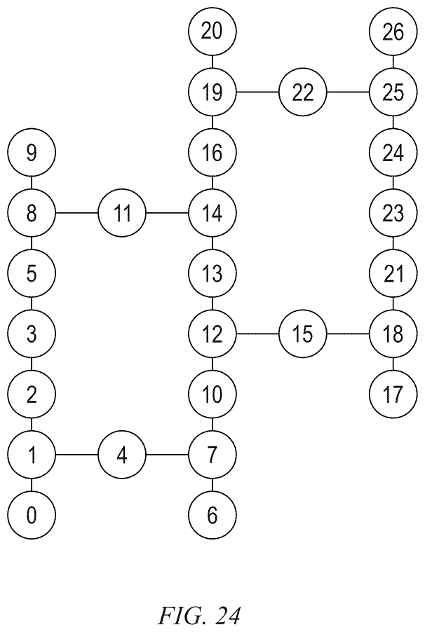

Refer now to FIG. 11, which depicts tuning examples on an IBM Falcon 27 qubit lattice. In FIG. 11, node frequencies are indicated by the legend 1035. Note that the non-regular lattice spacing in FIG. 11 is unrelated to the tuning behavior, but results from the aspect ratio of the rendering. FIG. 24 shows a regularly-spaced rendering of such a lattice. View 1017 is a “hand-made” plan where a human seeks to assign frequencies, to try and minimize the number of collisions by trial and error. The bar graph 1019 is a frequency distribution of the qubits, while the bar graph 1021 is a histogram of the percent tuning distance. The view 1023 shows the results when the minimum tuning solution is employed. The bar graph 1025 is a frequency distribution of the qubits, while the bar graph 1027 is a histogram of the percent tuning distance. The results are better than the handmade plan, and the tuning distance is weighted towards zero, as would be expected in a minimum tuning solution. The frequencies are weighted towards the high end, because tuning positive in resistance results in moving negative in frequency. View 1029 shows the perturbative, or optimized, solution without using minimum tuning. The bar graph 1031 is a frequency distribution of the qubits, while the bar graph 1033 is a histogram of the percent tuning distance. This brings the collisions down to the lowest level, and also has a more uniform frequency profile. It also permits utilization of more of the high end of the tuning side, resulting in lower frequencies, which is not achievable with the minimum tuning solution.

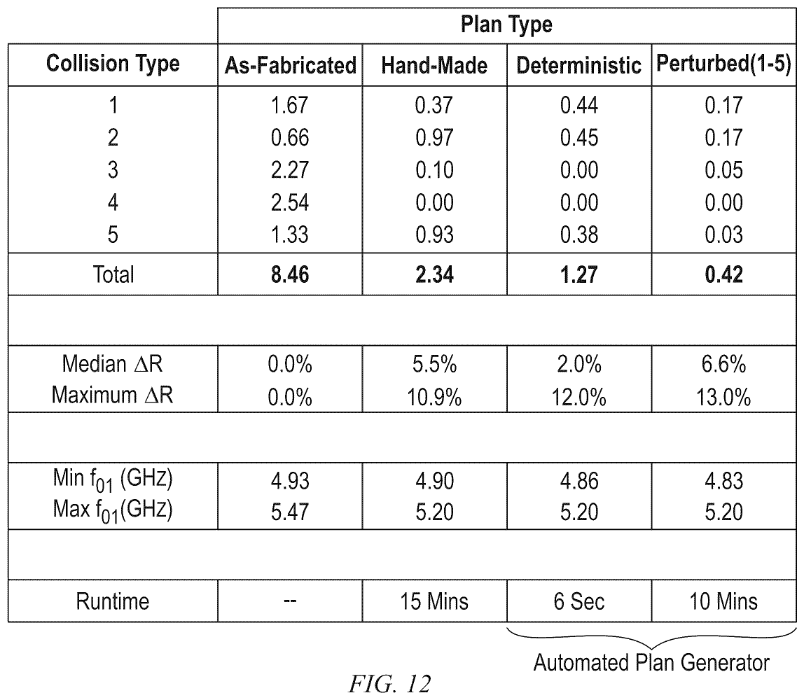

FIG. 12 is a table showing exemplary tuning plan performance for an IBM Falcon 27 qubit system. It can be seen that this system is already rapidly approaching chip sizes where hand-made plans are not feasible. In the example, only collision types 1 through 5 were considered. The handmade plan reduced the number of collisions, but took 15 minutes to implement. The deterministic plans typically take less than 10 seconds (6 seconds in the example), while the perturbation approach takes significantly longer (10 minutes in the example). The deterministic and perturbation plans were generated with an automated plan generator in accordance with aspects of the invention. The table was generated using Monte Carlo techniques with σ=20 MHz, where the frequency spread o is a parameter that indicates the amount of frequency scatter from an ideal resistance-to-frequency correlation curve for the qubits being tuned. Such frequency scatter may arise due to intrinsic imprecision in the frequency prediction precision, or may also arise due to the drift of the junction resistances due to aging, after LASIQ and prior to cooldown in a cryostat. In this particular example, optimization was performed for type 1-5 collision removal (multiple type 6/7 collisions were present in all cases but were ignored here by setting the collision bounds to be zero. However, a skilled artisan, given the teachings herein, can set collision bounds as needed for the quantum processor being tuned.). Generally, the optimized plan uses the entirety of the allowable frequency range to reduce mean collisions, which is a direct result of the perturbation routine which seeks to maximize the margins (thereby minimizing the risk) from entering collision bounds.

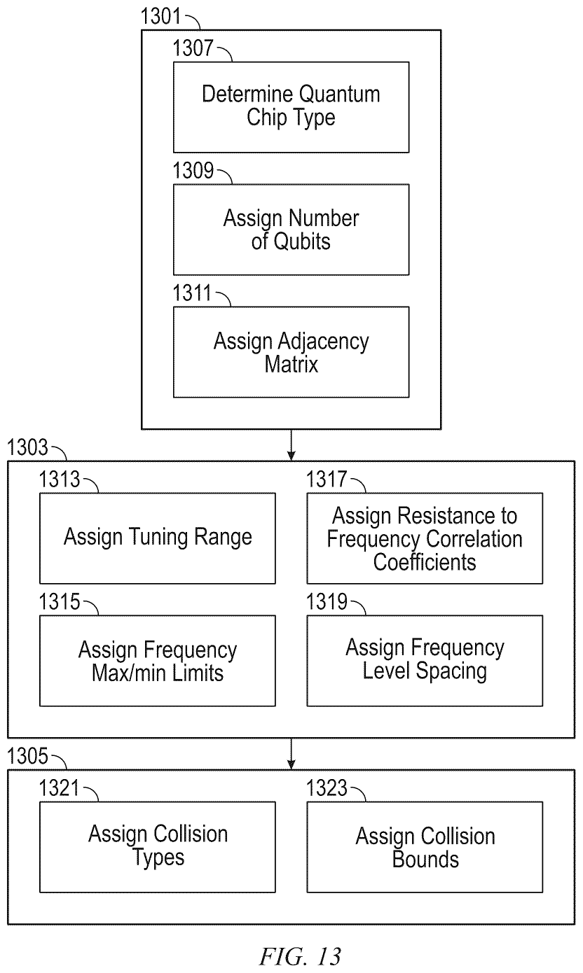

FIG. 13 depicts aspects of tuning plan initialization, generally including lattice preparation 1301, tuning parameter definition 1303, and collision parameter definition 1305. In the lattice preparation stage, the lattice and adjacency matrix is determined based on a template file, whereby lattice size, geometry, and connectivity are determined. Regarding the tuning parameter definition, the tuning parameters are how the tuning frequency levels should be assigned and spaced, and the frequency predictions based on junction resistances. As far as the collision parameter definition is concerned, this aspect is where the various collision types and bounds are provided.

Thus, first, prepare the lattice at 1301, including determining the chip type at 1307. The number of qubits assigned at 1309 is associated with the type of chip. Regarding the adjacency matrix assigned at 1311, this matrix shows which nodes are connected to each other. Now consider defining the tuning parameters at 1303. The tuning range assigned at 1313 can be, for example, 13%, 15%, or any other suitable value. This can be determined, for example, through calibration runs where various calibration structures may be utilized towards determining the typical tuning rate and tuning range of the Josephson junctions, using dedicated test structures that may be interleaved and/or situated on unused locations of the chip (for example, the ‘kerf’ of a chip, which is an unused location that physically separates two adjacent dies on a wafer, or coupon), or using a ‘sister’ chip, which has undergone the same process steps during fabrication. The correlation coefficients assigned at 1317 map resistance to frequency when the chip is cold. These coefficients can be determined empirically from historical data on other chips. The frequency maximum and minimum limits on each qubit assigned at 1315 are assigned based on the maximum tuning range available. A frequency level spacing is assigned at 1319; for example, 100 MHz. Regarding collision parameter definition at 1305, assign the collision types of interest at 1321 (for example, types one through six or types one through four). Assign collision bounds at 1323, corresponding to the desired gate error; for example, 0.5% or 1%. See FIGS. 1 and 2.

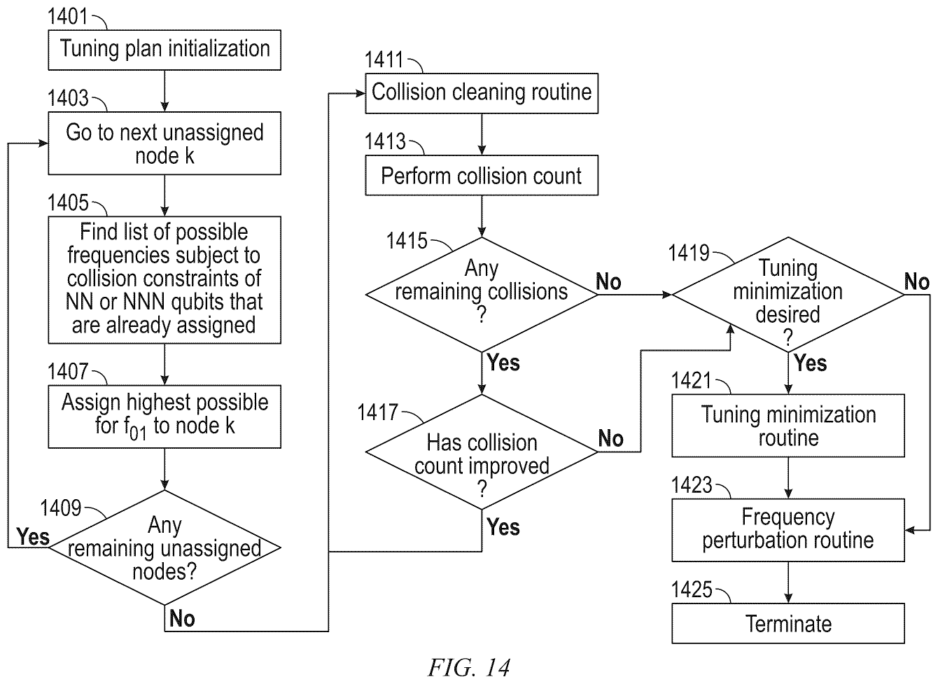

Turning now to FIG. 14, consider details of an exemplary tuning plan algorithm, in accordance with aspects of the invention. The exemplary tuning plan includes up to four stages: (i) collision build-out, (ii) collision cleaning, (iii) minimization routine (optional), and (iv) frequency perturbation routine. FIG. 14 thus depicts an exemplary flow chart for a complete tuning plan algorithm. Tuning plan initialization step 1401 can be carried out, for example, as per FIG. 13. The nodes, K, correspond to individual qubits; steps 1405 and 1407 are iteratively repeated as per step 1403 and decision block 1409 YES branch. In the assigning step 1407, assign the frequency to create the minimal number of collisions necessary. In one or more embodiments, the highest possible f₀₁ is assigned based on available frequency levels of a qubit that do not cause collisions of a determined type; this may range from any subset of type 1-7 (since there are a total of 7 collision types), and in some embodiments, may include supersets of frequency constraints beyond those listed in FIGS. 1 and 2. Once there are no more remaining unassigned nodes, proceed to the collision cleaning routine 1411, which brings the collision count to zero, or at least close to zero, as determined by step 1413. Iterate through the collision cleaning routine in accordance with decision blocks 1415, 1417 until all the residual collisions have been removed or the collision count does not improve upon successive iterations. If tuning minimization is desired, as per decision block 1419, perform the tuning minimization routine at 1421 and then proceed to the frequency perturbation routine at 1423; else proceed directly to step 1423. The flow terminates at 1425.

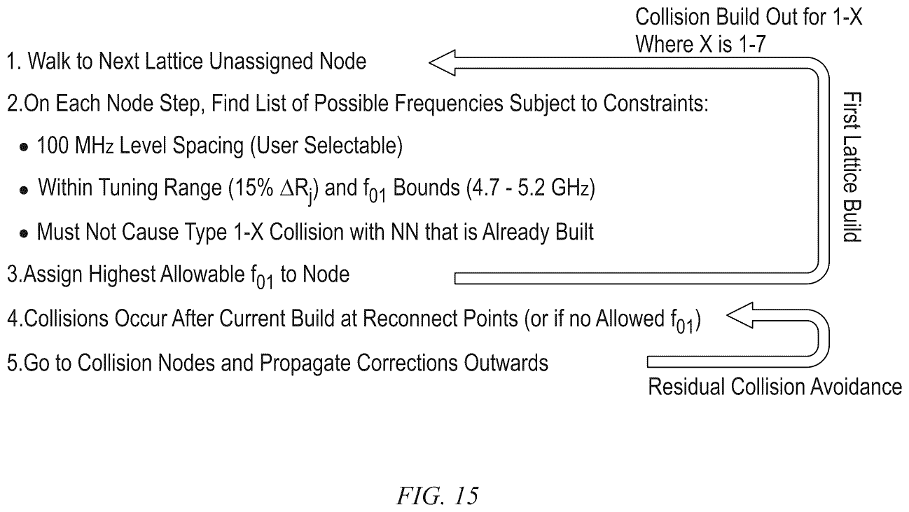

FIG. 15 provides additional description of the exemplary tuning plan algorithm. In the first lattice build (collision build out for collision types 1 through X, where X ranges from 1 to 7, or any subset of type 1-7), walk through the lattice to the next unassigned node. On each node step, find the list of possible frequencies, subject to constraints:

100 MHz (for example) level spacing (generally, user selectable)

Within tuning range (e.g., 15% tuning range) and f₀₁ bounds (e.g., 4.7-5.2 GHZ)

Must not cause type 1-X collision with nearest neighbor (NN) that is already built

Next, assign the highest allowable f₀₁ to the node.

Now, consider residual collision avoidance. Collisions occur after the current build at reconnect points (or if there are no allowed f₀₁). Go to the collision nodes and propagate corrections outwards. This is a pertinent aspect of the ‘collision cleaning’ method previously described. In some embodiments, half level spacing is permitted; for example, if 100 MHz level spacing is initially selected, the during the collision cleaning routine, if no levels are available, a half-level spacing of 50 MHz may be implemented to eliminate the collision. In general, any variation of a uniform level spacing may be implemented by the skilled artisan during the collision cleaning routine without alteration of the tuning plan methodology.

FIG. 15 thus provides a description of an exemplary tuning plan algorithm. As noted, NN stands for nearest neighbor (NNN stands for next nearest neighbor). In one or more embodiments, do not cause a new collision with a nearest neighbor that has already been assigned. Assign the frequency based on existing constraints of the surrounding neighbors. The residual collision avoidance is essentially a collision cleaning routine. This set of routines, as described, comprises the ‘deterministic’ aspect of the tuning plan generator. Subsequent to this deterministic plan generation phase, optionally, perform the perturbation routine, which is a pseudo-deterministic routine that relies on a ranking of the greatest number of collisions based on Monte Carlo modeling. As the Monte Carlo process is statistical in nature, there is a pseudo-determinism in the sense that generally the significance of each collision type (in terms of the number of collisions) will be similar if the process is repeated; however, the perturbative routine is typically performed over many iterations (e.g., over 100 times) and thus the outcomes will not be exactly identical each time. This process, both deterministic and perturbative, can be used for screening chips as well as tuning them; candidates can be ranked. For example, in typical screening of 6 Falcon-R4 chips, the runtime was about 90 seconds, demonstrating the computationally efficiency of the tuning plan generator and ranking process in the screening of multi-qubit processors from a batch of fabricated chips. This time of 90 seconds includes the time to parse the room temperature measure resistances, filter the chips according to achievable frequency range (for example, chips with as-fabricated qubits with frequencies outside of an allowable band would be rejected), followed by implementing the tuning plan generator and running the Monte Carlo analysis to estimate the expected number of collisions in the tuning plan. Based on the expected collisions, a final ranking of the candidates may be provided to the operator, who may select the chips to be tuned based on the ranking (from highest to lowest), or the tuning may proceed through an automated algorithm that may tune the candidates in order.

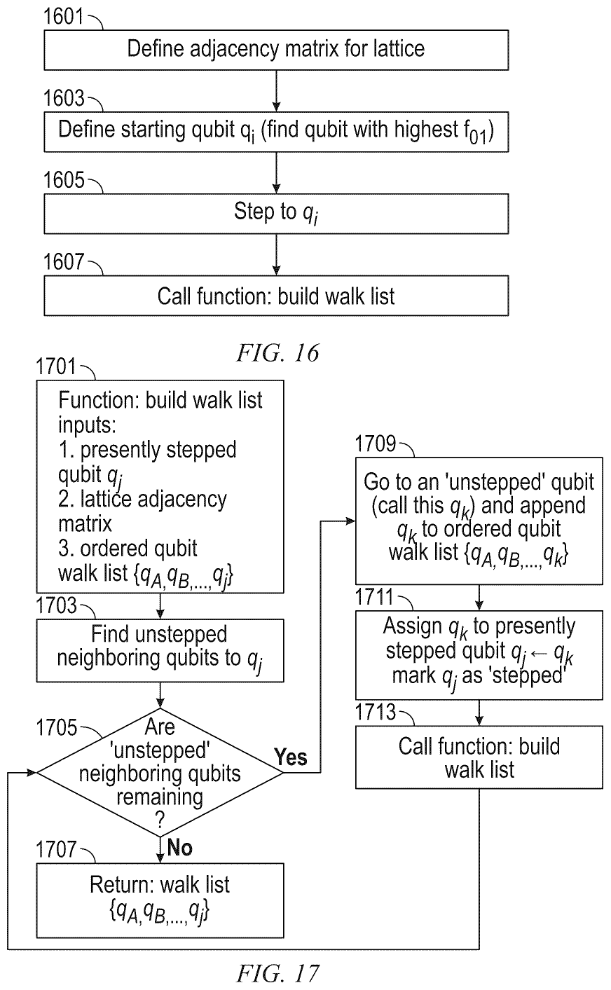

With reference to FIGS. 16 and 17, consider now an exemplary lattice stepping routine. This stepping routine is required in the initial phase of the deterministic tuning plan to provide an order in which each qubit frequency is assigned, with the goal of maximizing connectivity of each step such that there is a minimum of ‘reconnect’ points as described in FIG. 15. FIG. 16 depicts an exemplary function by which the lattice walk routine can be instantiated. In step 1601, define the adjacency matrix for the lattice. In step 1603, define the starting qubit, qᵢ, by finding the qubit with the highest f₀₁. Then, at 1605, step to the next qᵢ. The output of the function (build walk list) in step 1607 is a list of qubits that is recursively generated which, as continuously as possible, steps through qubits in the lattice.

FIG. 17 is depicts an exemplary function that builds the next step in the walk list; note that it is a recursive routine which calls itself. Once the walk list is built, the qubits are stepped through in this order (see “go to next unassigned node k”) in FIG. 14 step 1403. In particular, note that step 1713 instantiates another instance of function 1701, and the list of ‘stepped’ qubits continually increases (step 1709) with the depth of the recursion.

FIGS. 16 and 17 thus depict an exemplary a lattice stepping routine. FIG. 16 is a non-limiting exemplary embodiment of a lattice walk; it is possible to walk across the lattice in any desired manner. Generally, step to the next qubit that is not assigned; if there are no next nearest qubits that are not assigned, a jump may be possible. The example of FIG. 17 is a recursive method to minimize the number of hops. That is to say, the goal in one or more embodiments is to walk the lattice in as continuous a fashion as possible. The starting qubit is typically the qubit with the highest frequency, because that qubit will typically require the most tuning. FIG. 17 is thus the function “build walk list” mentioned in step 1607. In the box of inputs 1701 for the build walk list function, the inputs include the presently stepped qubit qⱼ, the lattice adjacency matrix, and the ordered qubit walk list {q_{A}, q_{B}, . . . , qⱼ}, which is an ordered list of qubits that have already been stepped on. This process maximizes the connectivity of the walk, which minimizes the possibility of building out too many collisions at reconnect points. In step 1703, find the unstepped neighboring qubits to qⱼ. In decision block 1705, determine whether there are ‘unstepped’ neighboring qubits remaining; if so proceed to step 1709, else return the walk list at 1707. In step 1709, go to an ‘unstepped’ qubit (referred to as qₖ) and append qₖ to the ordered qubit walk list: {q₄, q_{B}, . . . , qₖ}. In step 1711, assign qₖ to the presently stepped qubit qⱼ «qₖ and mark qⱼ as ‘stepped.’ Then, recursively call the build walk list function at 1713 and proceed to decision block 1705.

FIG. 18 is a collision cleaning routine, which can implement step 1411 in FIG. 14. This flow chart shows a single pass of the collision cleaning routine. The collision cleaning routine starts by performing a collision count at 1801 and determining a collision map and list of collisions at 1803; in essence, listing all collision pairs for the user-defined collision types (typically types 1-7, but, e.g., could be types 1-4 if only NN collisions are considered). There is an iterative process indicated by decision block 1805; keep iterating while collisions remain in the list, else end at 1807. In step 1809, go to the top element on the collision list. In step 1811, the available frequency levels are determined based on the frequency levels from the spacing (defined in the initialization), and the tuning range. In this step of listing the possible collision-free frequency levels for the given qubit pair, the collisions may typically involve two or three qubits. In decision block 1813, determine whether other f₀₁ levels are viable; if not, remove the collision qubit pair from the list in step 1819 and return to decision block 1805. If there are other viable levels, proceed to decision block 1815 and determine whether the new level reduces the collision count. In some embodiments, half-level spacings may be permitted. For example, if the initial level spacing of 100 MHz is selected, and no frequency levels are available such that the collision under consideration between neighboring qubits may be avoided, a half-level spacing of 50 MHz may be optionally permitted to eliminate the collision. In order to allow half-level spacings, the level spacing should be appropriately selected such that the half-level spacing is not likely to cause new collisions. Implementation of half-level spacing, or any other fractional spacing in general does not alter the nature of the collision cleaning routine, provided that a discrete number of levels are provided to the routine, which will then subsequently check each possible level in turn. The new levels are assigned at 1817 ONLY if collisions improve; otherwise, proceed directly to step 1819. For each iteration, the collision qubit pair is removed at 1819, until the entire list is iterated and 1805 yields a “NO.” In the main tuning plan of FIG. 14, this collision cleaning 1411 is repeated until there is no overall improvement in collision count.

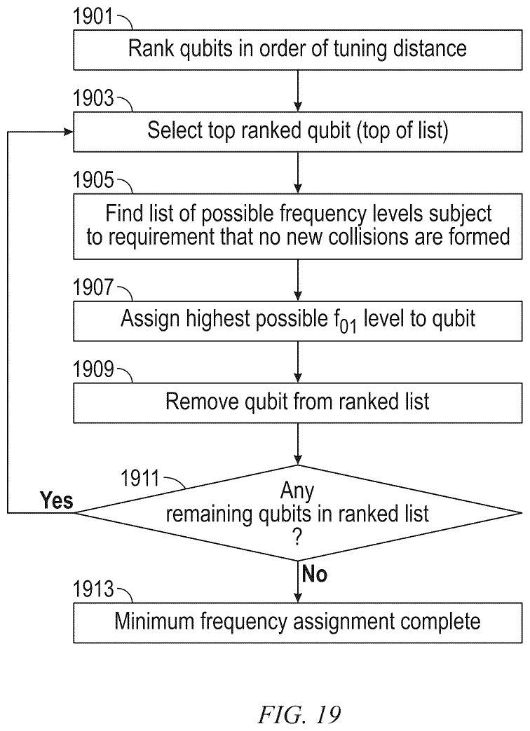

FIG. 19 depicts a tuning minimization routine, which can be used to implement step 1421 in FIG. 14. The routine minimizes tuning without creating any new collisions. This is typically possible after the collision cleaning routine 1411. The minimum tuning routine can be used, for example, when it is desired that qubit tuning be minimal to reduce the risk of running into tuning range limitations. This routine, although minimizing required tuning distance, will also cause generally higher Monte Carlo collision count, i.e., there is a trade-off between tuning range and collision outcomes, and the skilled artisan can use this trade-off as needed for the tuning process, given the teachings herein. In step 1901, rank qubits by required tuning distance, and then checking if another frequency level can be assigned without introducing more collisions, iterating until all qubits are checked. Thus, in step 1903, select the top ranked qubit (top of list). In step 1905, find a list of possible frequency levels subject to the requirement that no new collisions are formed. In step 1907, assign the highest possible f₀₁ level to the qubit. Then, in step 1909, remove the qubit from the ranked list. In decision block 1911, determine whether there are any remaining qubits in ranked list; if so, continue iterations; else, the minimum frequency assignment is complete at 1913.

FIG. 20 is an exemplary frequency perturbation routine. Begin with a frequency tuning plan at 2001. The Monte Carlo collision analysis 2003 will return the expected number of collisions by type; for example, type-1 collisions are the most frequent. In step 2005, identify the greatest contributing collision type-typically, whichever pair is closest to each other is the most likely contributor to a type one collision. In step 2007, for the greatest contributing collision type, obtain the most significant NN or NNN collision pair based on the NN or NNN f₀₁ difference. In step 2009, perturb the NN or NNN qubit pair apart, if the perturbation is within the tuning range of both qubits. In one or more embodiments, the perturbation amount is a user defined parameter; for example, 5 MHz.

Then, mark the qubit pair as corrected in step 2011 and increment the number of iterations in step 2013. In decision block 2015, if the maximum number of iterations has not been reached, continue iterating as logical flow returns to step 2003. Otherwise, complete the flow by identifying the iteration with the minimum Monte Carlo collision count, at 2017. In an exemplary embodiment, the maximum number of iterations may be set near or slightly above 100, as it is typically the case that further iterations beyond this will not yield substantial improvement in the expected collision count.

Thus, in FIG. 20, a frequency perturbation, or ‘nudge’ routine moves high-risk NN or NNN collision pairs apart. The routine starts by performing a Monte Carlo analysis at 2003, and identifying the most significant collision type contributing to the total collision count at 2005. For the specific collision type contributing most to the total collision count, the highest risk NN or NNN pair is identified at 2007 based on the frequency difference of the pair or triplet. In particular, identifying and mitigating collisions in rank order of high- to low-risk is an optimal method to statistically minimize collisions and therefore improve gate-fidelity for quantum computation while perturbing the least number of qubits from the existing plan. In an exemplary embodiment, we may utilize qubit detuning to rank the risk of collision for a particular collision type. For example, suppose the highest risk collision type is type-1, and 0.5% gate error bounds are considered (FIG. 2), such that type-1 collision bounds are 40 MHz. Suppose one pair of qubits Q_{A} and Q_{B} are detuned by 50 MHz, and another pair Qc and QD are detuned by 45 MHz. In this case, Qc and QD would be ‘higher risk’ than Q_{A} and Q_{B} since the former pair is closer to the 40 MHz type-1 collision bound. A similar ranking scheme may be applied to all other collision types, whether involving two- or three-qubit collisions. The qubit pair or triplet is ‘nudged’ (perturbed) (e.g., by 10 MHZ) apart in step 2009 to reduce the risk of collisions. The perturbation is only permitted if the qubit tuning range permits it. The process iterates for a user-defined number of iterations. In this exemplary embodiment, the two- or three-qubit detuning is used to rank the collisions in terms or risk; however, the perturbation method is not limited to this specific method or ranking, and any other method, statistical or otherwise, may be used to determine the highest-risk collision pair or triplet.

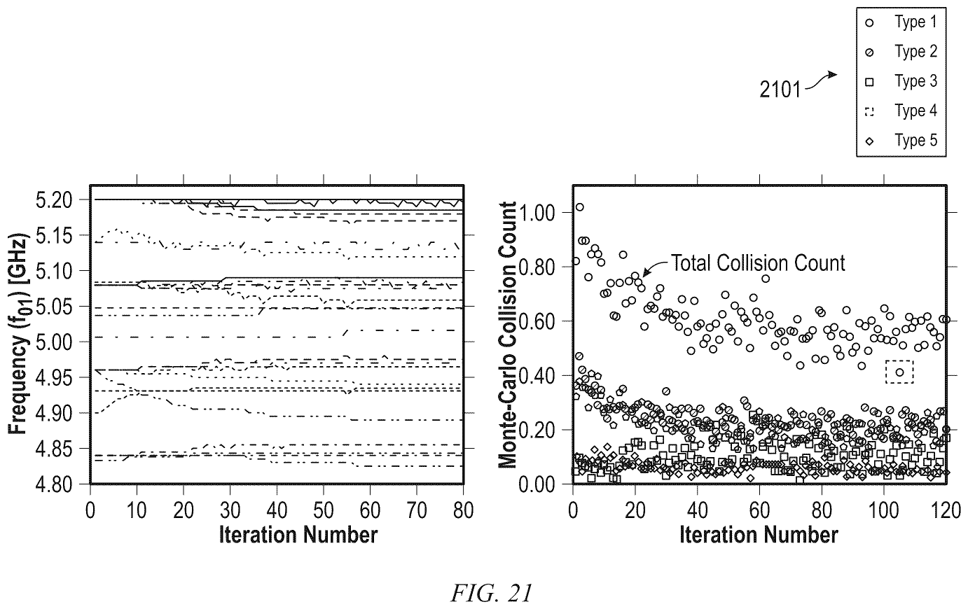

FIG. 21 shows example results of the frequency perturbation routine. Each dot in the round data points curve at the right-hand side of FIG. 21 is a total mean collision count from a Monte Carlo simulation. In the example, 120 iterations were carried out. As continuous iteration and nudging is carried out, the total number of collisions goes down and it is possible to pick the iteration that gave the best result, and is shown in the square box. The left-hand side of FIG. 21 shows how the individual qubit frequencies move with the number of iterations for 27 frequencies on a Falcon processor. Over time, with the perturbation, the frequencies spread out and fill up the frequency space. Thus, the impact of the frequency perturbation routine is to fill out the frequency space without causing any new collisions. This aspect will generally improve the overall collision count, at the cost of perhaps 10 minutes of runtime. In the example, each iteration takes about 5 seconds, such that 120 iterations takes about 10 minutes. The example splits the fixed-frequency levels to use the f₀₁ continuum between roughly 4.8 GHz to 5.2 GHZ, but other allowable frequency ranges may be defined, based on the specifications of the quantum processor being tuned. Some embodiments permit collision crossings; that is, a qubit may reach a forbidden collision bound, and may ‘hop’ across it by a large perturbation on the qubit frequency. We have found that the process typically will settle after about 100 iterations. Taking the tuning solution with the minimum count (marked with a square), in the example, the solution was iteration #105 for this Falcon chip. The collision types for the right-hand side are indicated in the legend 2101. On the left-hand side plot, the individual qubits are shown in different dash patterns for display clarity.

FIG. 22 shows a regularly-spaced rendering of single “Eagle” 127-qubit ‘heavy hexagon’ fixed-frequency transmon qubit lattice for an exemplary chip. Other lattice geometries are possible. One or more embodiments seek to mitigate ‘collisions’ and assign nearest-neighbor and next-nearest neighbor qubit frequency detuning to low gate error regimes; for example, in lattices of fixed-frequency transmon qubits with 7 collision types. Advantageously, at least some embodiments use an ideal 3-frequency pattern to avoid all 7 collision types. However, achieving such an ideal 3-frequency pattern can be challenging given tuning range constraints (typically 15% resistance), and as-fabricated spread (4-5% resistance). In such a case, where ideal 3-frequency patterns are not attainable due to tuning range constraints, it is possible to utilize computationally efficient deterministic and perturbative methods described herein, where the deterministic method steps through a lattice in a maximally connected way and builds out the qubit frequency subject to collision constraints and tuning range constraints, while the perturbative method maximizes the margins from collision bounds. In this manner, a computationally hard problem of finding a frequency tuning plan may be solved efficiently, thereby significantly increasing the throughput and permitting real-time adaptive solutions during the LASIQ tuning process. Such adaptive solutions advantageously accommodate cases where overshoot or undershoot of individual qubits may occur, and new plans must be generated in situ to avoid excess collisions and therefore low gate-fidelities. One or more embodiments provide a deterministic and perturbation routine, resulting in deviations from the ideal 3f pattern for tuning plans, since ideal 3f plans are not achievable.

FIG. 23 shows a regularly-spaced rendering of single “Hummingbird” 65-qubit ‘heavy hexagon’ fixed-frequency transmon qubit lattice for an exemplary chip. Other lattice geometries are possible. This lattice can otherwise have similar constraints and details as that of FIG. 22.

FIG. 24 shows a regularly-spaced rendering of single “Falcon” 27-qubit ‘heavy hexagon’ fixed-frequency transmon qubit lattice for an exemplary chip. Other lattice geometries are possible. This lattice can otherwise have similar constraints and details as that of FIG. 22.

Reference herein to IBM's Eagle, Hummingbird, Falcon, Osprey, Condor systems, and the like, are to be understood as exemplary and non-limiting, as aspects of the invention can be applied to many different systems.

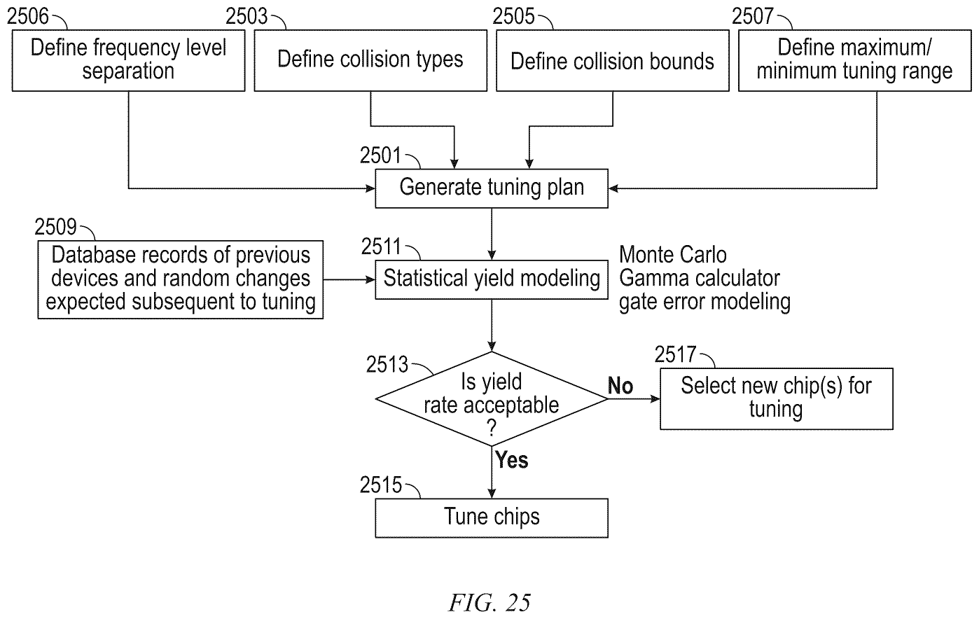

Turning now to FIG. 25, consider aspects of tuning plan generation. In one or more embodiments, a tuning plan is generated in step 2501, using an optimizer (non-limiting examples are discussed below), and is based on the tuning range constraints 2507, collision types 2503, frequency collision bounds 2505 for each collision type, and a selected frequency level separation 2506. Yield modeling is performed in step 2511 (based on the tuning plan and database records 2509; e.g., Monte Carlo, Gamma calculator (i.e., the estimated overhead for probabilistic error cancellation as known from the IBM Research paper Ewout van den Berg et al., “Probabilistic error cancellation with sparse Pauli-Lindblad models on noisy quantum processors,” Nature Physics, 2023 May 8:1-6), Gate error modeling)). If determined to be acceptable in decision block 2513, the chip is tuned in step 2515; otherwise a new chip may be selected for tuning in step 2517. The database record 2509 may, for example, be related to historical frequency spreads, which may typically be around 20 MHz; that is, the precision to which qubit frequencies may be determined using room temperature junction resistance data is approximately 20 MHz, where this spread contains contributions from the frequency prediction precision as well as junction aging prior to cooldown and measurement. Collision bounds could be, for example, 1% gate error or 0.5% gate error as shown in FIGS. 1 and 2. In one or more embodiments, in step 2507, define the maximum and minimum tuning range available for qubits that are going to be tuned; this can be obtained from calibration runs on sets of trial junctions with similar or identical characteristics to the junctions being tuned. Database records 2509 can be obtained from empirical observations of a number of devices that have been cooled to determine what type of frequency spreads can be anticipated; when fed into the statistical yield models 2511, it can be determined what at least some of the possible imperfections are. Database records 2509 can include, for example, statistics and measured outcomes of previous devices and random changes expected subsequent to tuning.

Note that Gamma is an expression of overhead for how many computer runs must be made/time of compute, and improves with corresponding improvements to qubit coherence and reduction in collisions. By reducing this runtime overhead, a greater number of qubits may be run with greater circuit depth, leading to the ability to implement deeper quantum circuits which may be used, for example, in the case of probabilistic error correction.

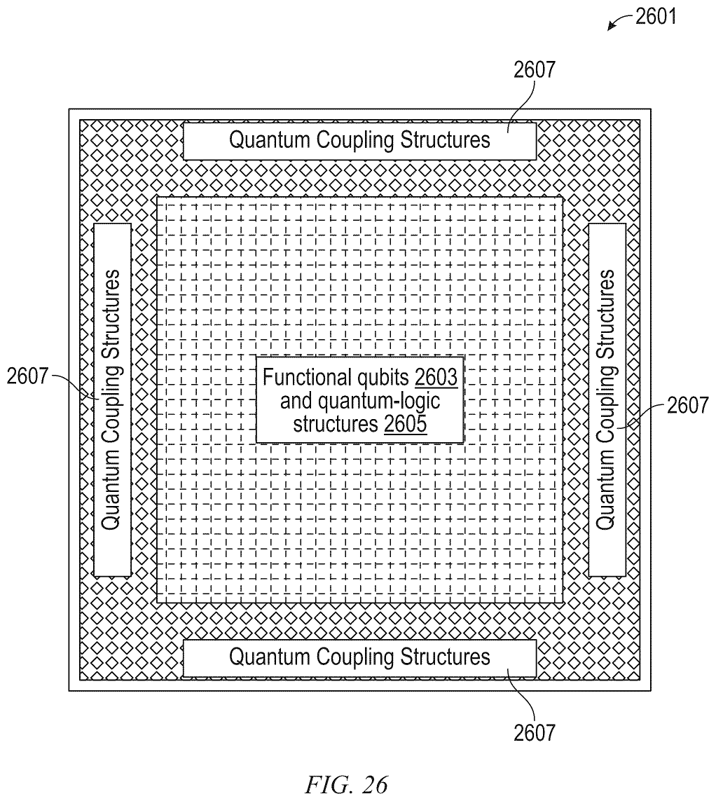

FIG. 26 shows aspects of tuning of modular devices and non-cross-resonance devices. Some modular devices have functional qubits and logic structures in the middle of the chip, with coupling structures at the edges of the chip. This can also be tunable. FIG. 26 is thus a schematic drawing of single chip 2601 to be handled in accordance with aspects of the invention. This illustration presents a microchip which serves as one modular element in a modular quantum processing unit (QPU). Generally, each individual chip includes a set of functional qubits 2603 and quantum-logic-related structures 2605, and a second set of quantum coupling structures 2607. Each such module will typically need to contain two distinct types of elements. The functional qubits and other quantum-logic structures store, manipulate or transfer quantum logic within the module, while the quantum coupling structures enable such actions from one module to another. In FIG. 26, the functional qubits 2603 and quantum-logic structures 2605 are placed in the chip interior and the quantum coupling structures 2607 are placed along the chip edges; however, other arrangements may be used in practice. In one or more embodiments, all structures are made of superconducting materials on a dielectric substrate and all structures contain Josephson junctions whose tunnel-barrier is susceptible to tuning by laser-annealing. Structures may include qubits of various kinds, or SQUIDs (superconducting quantum interference devices), or single Josephson junctions, or other combinations of Josephson junctions, capacitors and inductors. They may be galvanically, inductively, or capacitively linked with neighboring structures on-chip. The functional structures may contain Josephson junctions that are of different design or construction as compared to the Josephson junctions in the quantum coupling structures. The several types of Josephson junctions typically undergo calibration to determine their response to laser-power and exposure time. These separate calibrations determine the tuning range and tuning rates specific to the functional structures and to the quantum coupling structures.

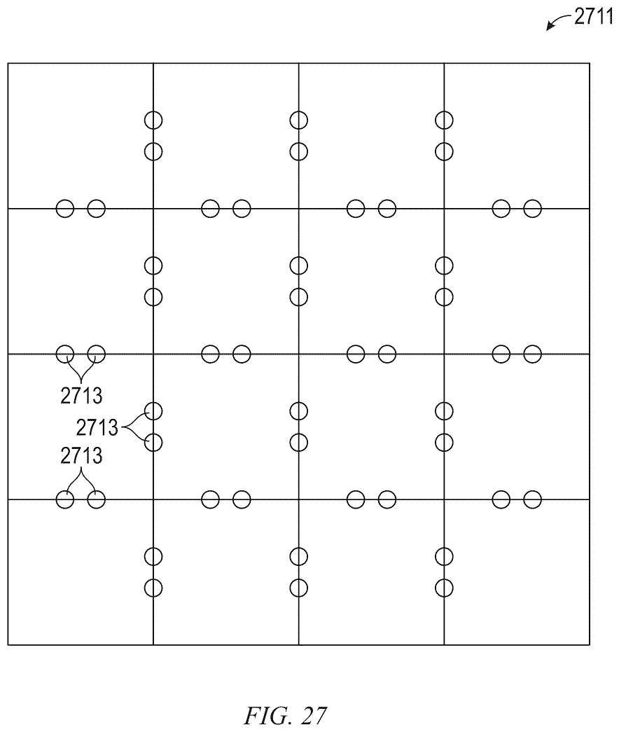

Referring to FIG. 27, each one of the chips can go inside of a coupling manifold. The example shows a four-by-four manifold, and there are links between the modules. A goal of one or more embodiments is to populate the manifold with the devices. This is an inherently complex problem, because it involves not only optimizing the frequency configuration of the chips internally, but also to optimize the couplings between the modules. Therefore, it is not possible to merely arbitrarily assign frequencies at the coupling links, due to possible internal frequency assignment conflicts. Referring still to FIG. 27, modularity is believed to be highly desirable for future scaling of quantum computers. Practically, it is prohibitively challenging to scale beyond the multi-thousand qubit range using existing superconducting qubit architectures on a single quantum chip. FIG. 27 shows a modular device manifold 2711 with sixteen subcomponent (chip) locations (the sixteen square boxes, not separately numbered). One or more embodiments provide an optimal way to populate these locations on the manifold with chip candidates; i.e., techniques to select appropriate chips to install into each of the modular sites and link to the other sites in the manifold. One or more embodiments provide a heuristic optimization routine that can work in real-time, and is feasible to solve. In a non-limiting example, the chips to be coupled may make use of fixed-frequency architectures such as transmon qubits for their functional qubits and quantum logic structures 2605, whose frequencies may be tuned using LASIQ and/or any other frequency tuning method. These transmon qubits may be coupled to quantum coupling structures 2607 which contain Josephson junction elements and may therefore be tuned using LASIQ. In one or more other embodiments, flux-tunable architectures that involve both fixed-frequency transmon qubits and tunable coupler elements may be used to form the functional qubits and quantum logic structures 2605. Each of the fixed frequency transmon qubits and/or tunable coupler elements (e.g., SQUID loop) contain Josephson junctions with may also be tuned using LASIQ. In one or more other embodiments, the functional qubits and quantum logic structures 305 may contain flux-tunable qubits. It is generally to be understood that the functional qubits and quantum logic structures 2605 and quantum coupling structures 2607 will include at least one and possibly several types of elements including one or more Josephson junctions, as well as microwave lines and other microwave elements such as capacitors and inductors.

An example of a functional qubit is a fixed-frequency transmon or tunable transmon. An example of a functional quantum-logic structure is a quantum-logic gate element (such as a SQUID-tunable resonant coupler) engineered to link two functional qubits within the chip. An example of a quantum coupling structure is a quantum-logic gate element (such as a SQUID-tunable resonant coupler) engineered to link a functional qubit on one chip to a functional qubit on another chip.

In FIG. 27, note that in some embodiments the links between modules will employ frequency-resonant elements fixed to the coupling manifold, so that the quantum coupling elements should have frequencies compatible with these resonant elements. For instance, such links may employ microwave resonators 2713. There will also be sites for direct links between quantum coupling structures 2607 of the individual chips as seen in FIG. 26; these links will be mediated by microwave lines or couplers on the coupling manifold extending across the boundary between adjacent chips, and in this case the quantum coupling elements on either side should have frequencies compatible with one another.

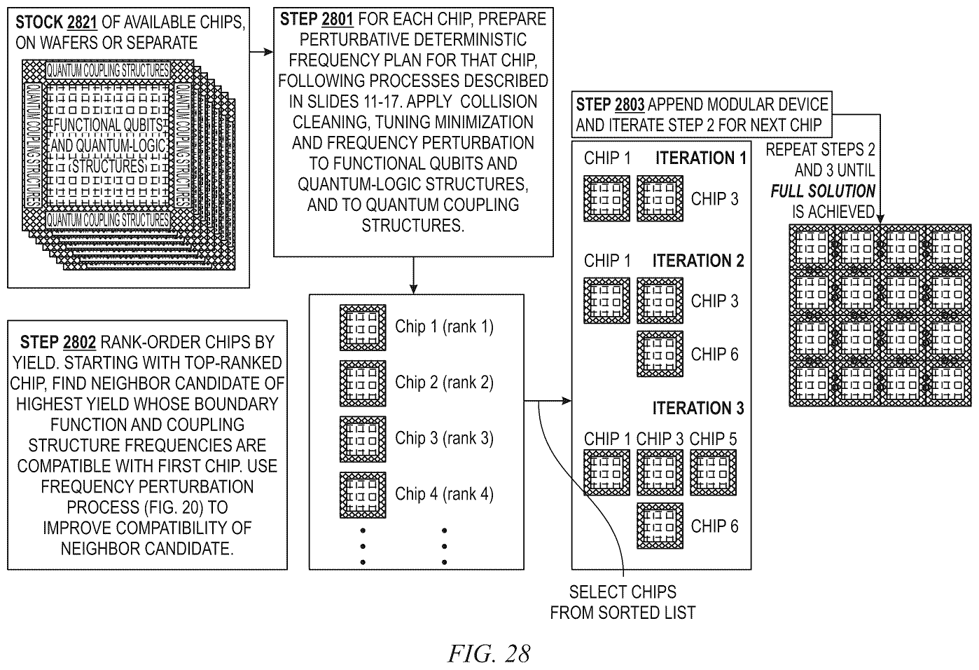

FIG. 28 shows one method for using the perturbative and deterministic process to satisfy some of the requirements. The ranking of the chips can be based on the yield assessment; for example, the probability of 0 collisions. FIG. 28 shows a first tuning plan example, for a linear chip build. In step 2801, prepare, from the stock 2821, a frequency plan as per techniques disclosed herein. In step 2802, find the best neighbor candidate by going through the candidates in rank order based on yield (selecting the chips from the sorted list, as indicated) and perturbing boundary function and coupling structure frequencies. The results of three iterations are shown to the right of step 2802. In step 2803, append the modular device identified in the most recent iteration. This process is repeated until a full solution is achieved (in the example, until all 16 available spaces are populated). Using this linear build for the modular device, at each stage, the best possible candidate is selected to couple into the existing structure until finally, the full modular device is completed.

In Step 2802, find the best chip, and then the next best chip that will couple. In the process of matching, also use the frequency perturbation process on the quantum coupling structures at the edges. Basically, find the best chip, and then the next best chip that can couple. The next best chip can be found by going through all the chips in a linear fashion based on their rank order by functional yield. The perturbative generator can even be implemented for each one to find the best one, and then it can be attached. In the example, that initially gives chip one and chip three. In the second iteration, linearly search through all the remaining chips to find the next best one. In the example, it is chip six attached to the bottom of chip 3. In one or more embodiments, keep appending chips using the tuning plan generator, and keep perturbing the frequency through the fixed frequency levels. The perturbative part here refers to “nudging” the frequencies, for example, by 5 MHz each time. Iterate the appending of candidates until the entire manifold is filled and the full solution is achieved.

Thus, if it is desired to make a modular device, the entire process could be employed: the build out, the cleaning, the perturbation, and the frequency shift minimization. This yields a batch of chips that have had tuning plans applied to both the functional qubits and also the coupling structures. In order to place the chips into the module, it may be sufficient to just use the perturbation process on those chips in order to get them to optimally fit with one another into the module. It may be sufficient to apply that frequency perturbation process only to the coupling structures, or perhaps only to the coupling structures and the qubits that are directly connected to the coupling structures. The nature of the perturbative process is such that it only perturbs if it does not create any new collisions. In one or more embodiments, the perturbative process will not be implemented if it makes a coupled chip worse; it will simply move it if it is possible. It can be defined within the perturbative routine to what extent it is permissible to perturb a chip. For example, the perturbation can be limited to just the quantum coupling structures, or, for example, alternatively, limit the perturbation to the quantum coupling structures and the qubits that are directly connected to them. The restrictions or conditions may be somewhat different for the coupling structure than they are for the rest of the qubits. In general, the nature, bounds, and definition of the collisions will be different for the coupling structures than for the qubits that are to be used for the quantum logic within the chip (that is, there is a distinction between the coupling structures on the edge of the chip and the qubits within the chip (i.e. interior qubits)). One or more embodiments thus provide a way to divide the work, and to use different parts of the tuning plan process for different parts of the modular work.

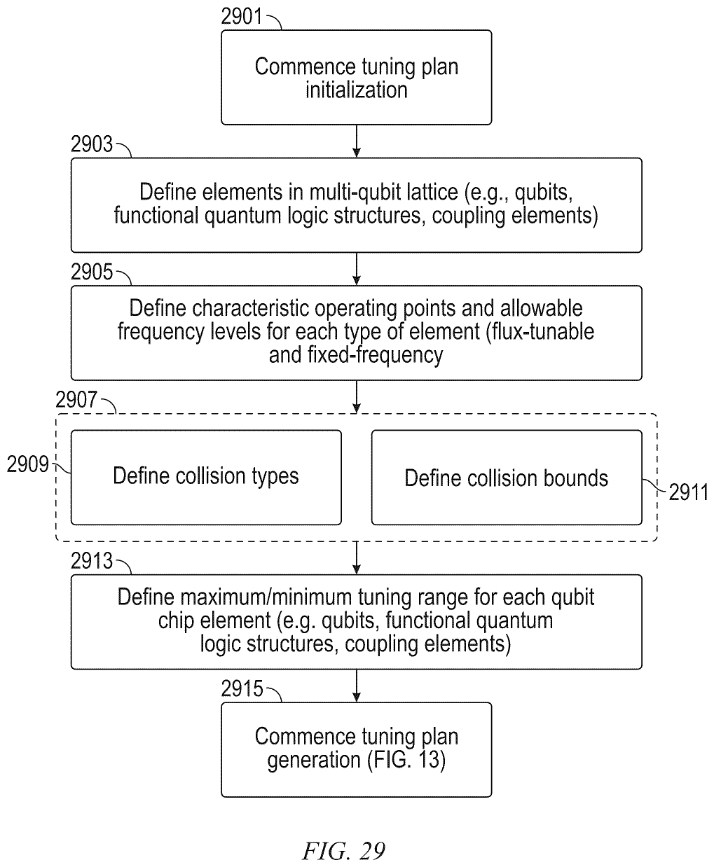

FIG. 29 depicts a generalization for the tuning plan for a multi-qubit chip with flux-tunable elements (e.g., tunable couplers)—for both deterministic and perturbative aspects. The process begins at 2901. In step 2903, pick tunable elements in the lattice. In step 2905, pick characteristic operating points or operating frequency ranges for each elements in the processor (e.g., the operating frequency range for fixed-frequency qubits, or the upper sweet spot in a SQUID for flux tunable architectures). Presume adjusting, for example, either the operating frequency or characteristic point in flux tunable range (the adjustment here is general, and can be applied to fixed frequency elements, tunable elements, or any other elements). In general, the adjustment may be applied to any element including Josephson junctions, with the result being a change in operating frequency or characteristic operating point, or any other operating parameter that affects the behavior or interaction with neighboring elements. Tunable elements are liable to have different functions than non-tunable elements. For example, transmons and tunable elements may perform different functions in the lattice. Tunable elements could include a coupler for a gate. Tunable elements can draw from a different set of allowable levels. There may be a third set of levels for other types of tunable structures. Different types of collisions can have different exclusion zones. For example, a collision may include multiple elements, such as a fixed frequency qubit, a tunable qubit, and a tunable coupler element.

With further regard to the step 2905 of defining characteristic operating points, every one of the components has characteristic operating points, allowable frequency levels, and so on, more or less regardless of the type of device. Once the frequency constraints and the frequency levels that can be assigned are known, it is possible to start to define what type of frequency avoidance zones are desired; they are referred to in the figure as collisions. In this regard, at 2907, note the definition of collision types at 2909 and collision bounds at 2911. The exemplary methods are typically agnostic to the type of device, as long as it is known what frequency levels are allowed and frequency exclusion zones to avoid.

In step 2913, define the maximum/minimum tuning range for each qubit chip element (e.g., qubits, functional quantum logic structures, coupling elements), and then commence tuning plan generation at 2915, referring to FIG. 13.

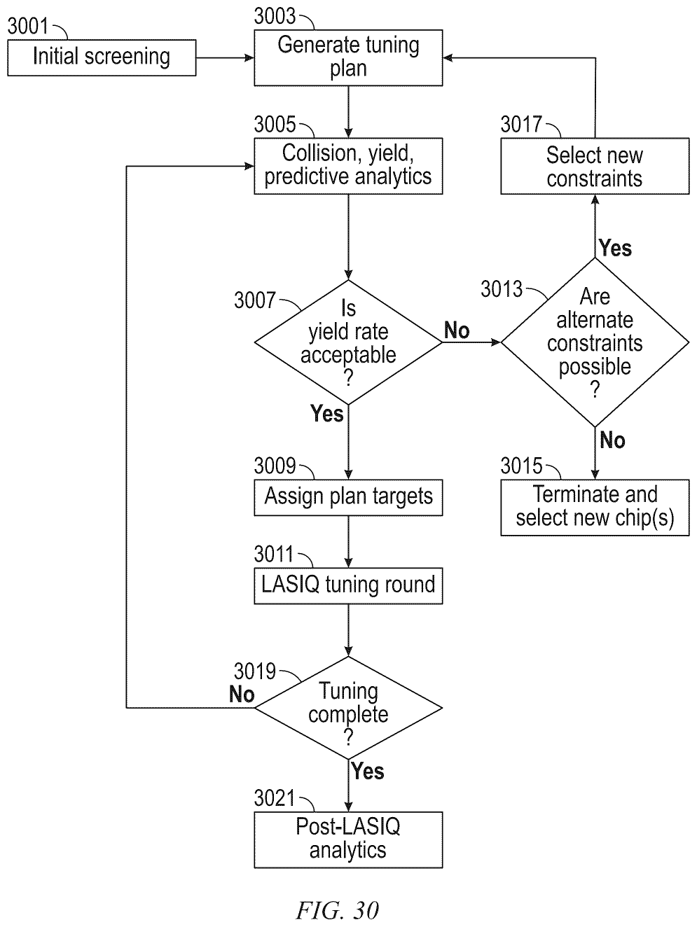

FIG. 30 shows aspects of tuning plan generation and tuning flow. FIG. 30 shows an exemplary process of feedback for in situ yield improvement by regenerating new tuning plans as the tuning progresses. Indeed, FIG. 30 shows aspects of feedback during tuning. In step 3001, carry out initial screening. In step 3003, generate a tuning plan. In step 3005, perform predictive yield analysis (e.g., Monte Carlo analysis) and collision analysis in-situ during LASIQ tuning. In decision block 3007, determine whether the yield rate is acceptable. If so (YES branch), assign the plan targets to the lattice in step 3009, and then proceed to LASIQ tuning in step 3011. On the other hand, if the yield rate is not acceptable (NO branch of decision block 3007), proceed to decision block 3013 and determine whether alternate constraints are possible. Alternate constraints may, for example, involve new acceptable collision-free bands of allowable frequencies for each qubit based on a new tuning plan. Alternate frequency constraints may also, for example, be based on the ability of the qubits to tune in a negative frequency direction, or bi-directionally. In such a case, new frequency tuning limits may be implemented on an existing set of qubits to allow for in situ correction of imperfections arising from overshoot or undershoot of qubit frequencies. We have found that the regenerated tuning plan will often be quite different than the original. In this sense, each chip at any given time may be considered to be an entirely new chip, merely with different boundary conditions from its previous rounds of tuning. If alternate constraints are not possible (NO branch of block 3013), terminate the process and select new chip(s) for screening at 3015. If alternate constraints are possible (YES branch), select the new constraints in step 3017 and return to step 3003 to generate a new tuning plan. Predictive yield analytics 3005 is performed, and if it is satisfactory in decision block 3007, the new plan targets are assigned at 3009. After the LASIQ tuning in step 3011, determine in decision block 3019 whether tuning is complete. If not (NO branch), logical flow proceeds back to step 3005 to assess the quality of the tuning round. On the other hand, if tuning is complete (YES branch), proceed to post-LASIQ analytics in step 3021.

Thus, FIG. 30 relates to tuning plan generation and tuning flow. In one or more embodiments, each time a tuning plan is generated at 3003, run predictive analytics (e.g., Monte Carlo) at 3005. If the yield rate is not acceptable, constraints can be modified, e.g., increase the tuning range, or change collision weights/bounds. This process iterates until a good tuning plan is found, then a LASIQ tuning round is performed at 3011. After each round, the tuning is checked at 3007 to ensure the yield rate is still acceptable, otherwise the constraints may again be modified to generate a new tuning plan. In one or more embodiments, tune each qubit progressively using successive annealing iterations. One tuning round means tuning across all the qubits on the chip, in a round-robin format as defined previously. Possible alternate constraints include different collision boundaries, different frequency tuning limits, acceptable operating frequencies for qubits, or the like.

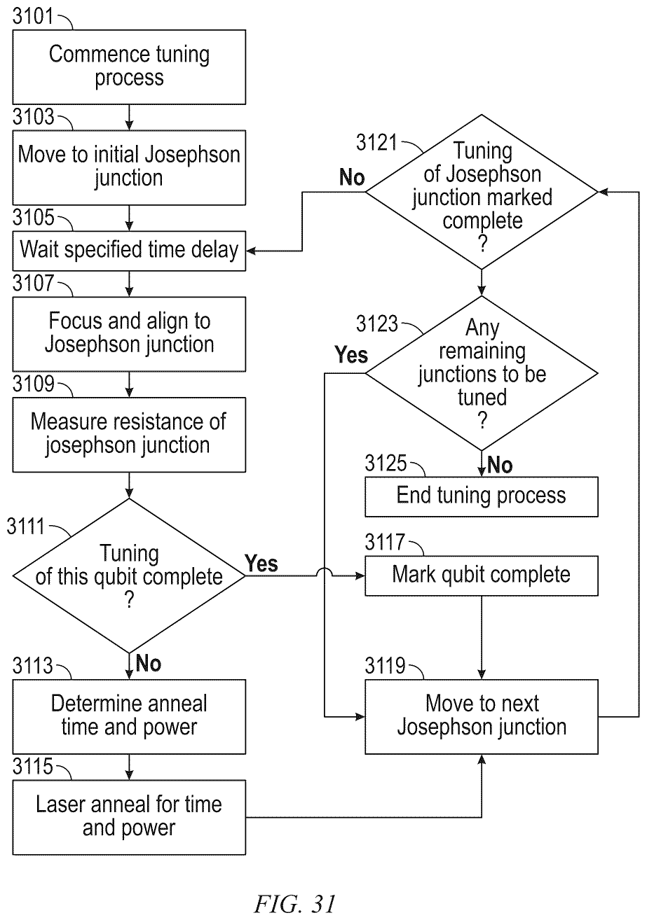

FIG. 31 depicts aspects of iterative tuning rounds. Commence the tuning process in step 3101. In step 3103, move to the initial Josephson junction. In step 3105, wait a specified time delay. This time delay may, for example, be a fixed time delay or may be a variable time delay to allow time for the junctions to settle from the prior tuning round. In step 3107, focus and align to the Josephson junction. In step 3109, measure the resistance of the Josephson junction. In decision block 3111, determine whether tuning of the given qubit is complete. If not, proceed to step 3113, determine anneal time and power, and then in step 3115, laser anneal for the determined time and power. Then, move to the next junction at 3119. On the other hand, if decision block 3111 yields a YES, mark the given qubit complete at 3117 and move to the next junction at 3119.

The tuning process determines whether the currently measured junction resistance (denoted R_{current}) of the given Josephson junction is at or near a target junction resistance (denoted R_{target}) for the given Josephson junction in 3111. In some embodiments, the given Josephson junction will be deemed to be at its target junction resistance R_{target} when an absolute difference between the measured junction resistance R_{current} and the target junction resistance R_{target} is within some specified threshold percentage of the target junction resistance R_{target}, i.e.,

$$\frac{\vert {R}_{target} - {R}_{current} \vert}{{R}_{target}} \leq x .$$

In some embodiments, x=0.003 (or 0.3%). For example, assuming the given Josephson junction has a target junction resistance R_{target}=10K Ohms, the given Josephson junction will be deemed to be at its target junction resistance R_{target} when the measured junction resistance R_{current} is in a range of about 9,970 Ohms to about 10,030 Ohms (i.e., about +/−30 Ohms around R_{target}).

If it is determined that the measured junction resistance R_{current} of the given Josephson junction is not at or near the target junction resistance R_{target} for the given Josephson junction (negative determination in block 3111), the tuning process proceeds to determine the anneal time and the laser power to utilize for laser annealing the given Josephson junction for the given iteration, based on the measured junction resistance in 3113. In particular, the tuning process will determine a remaining amount of resistance shift (denoted ΔR_{remaining}) needed to reach the target junction resistance R_{target} of the given Josephson junction based on the currently measured junction resistance R_{current}, where ΔR_{remaining}=R_{target}−R_{current}. The pulse time for the given laser anneal iteration at a given laser power level is determined based at least in part on a function of ΔR_{remaining} and a total amount of annealing time spent for previous “pulses” performed in previous tuning iterations of the given Josephson junction.

In decision block 3121, if the next junction is complete, move to decision block 3123, while if the next junction is not complete, move to step 3105. In decision block 3123, if no junctions remain to be tuned, end at 3125; else, move to the next junction at 3119.

Thus, in essence, go through the lattice, given a qubit, move to the next junction, and keep tuning each junction progressively using successive annealing iterations until they are all marked complete. End the process when there are no remaining junctions to be tuned. Multiple tuning rounds can be carried out until the tuning is deemed complete. An iterative approach is thus provided to resistance targets for each junction. A delay may be implemented to allow relaxation of resistances before the next annealing iteration on a qubit.

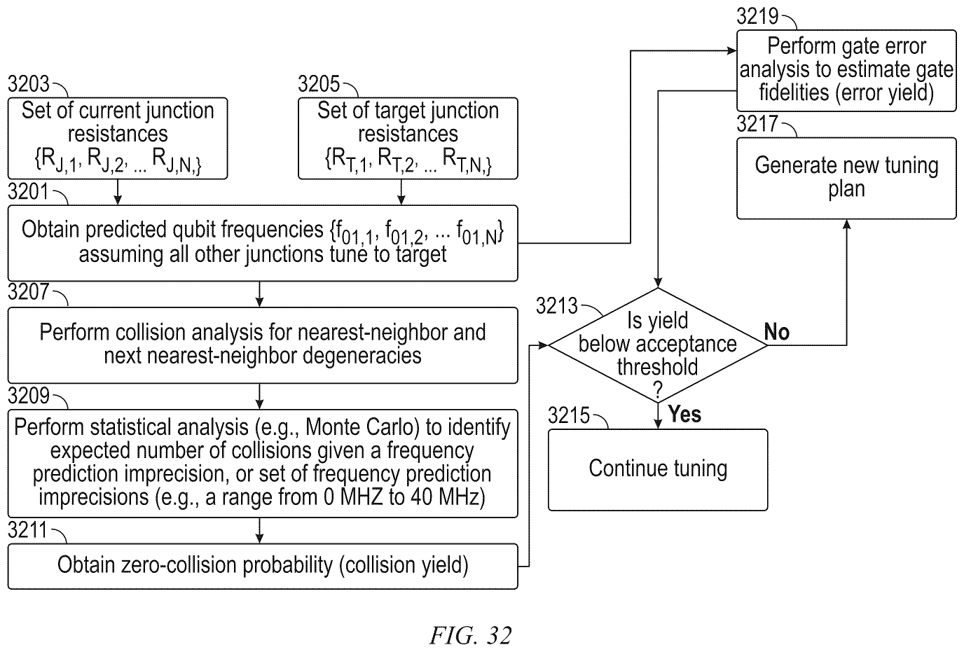

FIG. 32 shows aspects of yield assessment. In step 3201, obtain predicted qubit frequencies {f_{01,1}, f_{01,2}, . . . f_{01,N}} assuming all other junctions tune to target, based on input 3203 (set of current junction resistances {R_{J,1}, R_{J,2}, . . . . R_{J,N},}) and 3205 (set of target junction resistances {R_{T,1}, R_{T,2}, . . . . R_{T,N}}). In step 3207, perform collision analysis for nearest-neighbor (NN) and next-nearest-neighbor (NNN) degeneracies. In step 3209, perform statistical analysis (e.g., Monte Carlo) to identify the expected number of collisions given a frequency prediction imprecision, or set of frequency prediction imprecisions (e.g., a range from 0 MHz to 40 MHz). In step 3211, obtain the zero-collision probability (collision yield). In decision block 3213, determine whether the yield is below an acceptance threshold. If yes, continue tuning at 3215; else, generate a new tuning plan in step 3217. Returning back to step 3201, in a parallel path to steps 3207-3211, in step 3219, perform gate error analysis to estimate gate fidelities (error yield).

Thus, advantageously, it is possible to quantify how well tuning is proceeding by quantifying collisions and zero-collision probability and gate fidelity and defining acceptance thresholds; in one or more embodiments, this can occur in situ while tuning. The yield assessment aspects of FIG. 32 relate to the yield block 2511 of FIG. 25, and also to block 3005 of FIG. 30. Collision analysis can be performed for the data in the tables such as 1.0% and 0.5% gate error bounds in FIGS. 1 and 2. In one or more embodiments, perform statistical analysis (e.g., Monte Carlo) in step 3209 to identify expected number of collisions given a frequency prediction imprecision (e.g., 20 MHz), or a set of frequency prediction imprecisions (e.g., a range from 0 MHz to 40 MHz of freq. spread). With regard to the step of generating a new tuning plan in 3217, if no new tuning plans are available, it is appropriate to pick a different chip. Yield assessment can be used on tuning plans or additionally performed in situ during the tuning. There are two alternative ways to go from step 3201 to decision block 3213. The branch 3207-3209-3211 in itself does not provide a gate fidelity number, but rather assesses the expected number collisions for a given spread and therefore quantifies the probability of obtaining high gate fidelities. The branch through step 3219 estimates actual gate fidelities based on gate-error models and may be similarly used to define an acceptance threshold for the tuned quantum processors.

One or more embodiments thus provide a method including generating a tuning plan for a quantum computing device based on a perturbed fixed-level pattern generator, where the goal is to minimize collisions subject to collision types and bounds; and determining whether the yield rate is acceptable based on screening analytics, e.g., Monte Carlo or gate error modeling.

Further, one or more embodiments provide a tuning plan generator including: a lattice stepping routine, where a maximally continuous and connected set of qubits are listed in step-order; a fixed-level frequency plan generator to identify appropriate frequency levels for a qubit to be tuned; a perturbation routine, to modify qubit frequencies and move them outside collision zones; a tuning minimization routine, to check if less tuning can be implemented while maintaining or improving collision counts; a collision cleanup routine, which allows collision swapping and intermediate level spacing; and constraints, based on collision types, collision bounds, tuning range, and collision weights.

Still further, one or more embodiments provide a tuning technique for modular devices, including: a method to initialize the tuning plan generator for each candidate quantum processor candidate, whereby each candidate chip includes a set of qubit structures, functional quantum logic structures, and coupling structures; identifying a plurality of candidate chips to be arranged in a modular quantum processor; selecting a top ranked candidate by estimated functional yield, and populating the modular manifold with the top ranked candidate; and finding, from the stock, a best neighbor candidate for the top ranked chip by yield, based on frequency perturbation of the coupling structures; and repeating the steps of selecting and finding until a full solution is achieved.

Even further, one or more embodiments provide a tuning method, including an iterative and adaptive method to accurately and precisely approach qubit frequency targets; and/or a tuning apparatus, including a laser tuning system and a processor to execute the tuning plan and screening analytics.

Regarding the initial screening in 3001, screening is used to ensure that all chip candidates allocated for tuning are of sufficient predicted post-tuning quality that they should be entered into the LASIQ tuning queue. Generation of a tuning plan in 3003 can be achieved using any variety of tuning plan generators that may be used to satisfy frequency constraints and achieve target gate fidelity. Such tuning plans include fixed-frequency patterns, fixed-frequency levels, optimizer solutions involving significant computational requirements, ad-hoc plans, or the like.

A pertinent input to the statistical analysis will be any random changes to be expected in qubit frequencies between the time of LASIQ tuning and the time of chip cooling and operation in a cryostat. These may be estimated from records of past devices as previously measured and stored in a database 2509 accessed by the statistical yield modeling algorithm 2511. Additionally, there is a material relaxation of the Josephson junction that occurs post-annealing, where junction resistances relax and stabilize to their final values, and this relaxation may be compensated and/or accommodated using an appropriate time delay between post-LASIQ and cryogenic frequency measurements, as per step 3105.

Other algorithms employing the deterministic and perturbative tuning plan generator may, for example, attempt to optimize the utility of quantum processors by computing the longest possible collision-free chain, ring, or other such conformation given the constraints on tunability, collision bounds, and lattice geometry. Tuning plan generators using randomized plan generators or ad-hoc generators can also be used, for example, in the case of Monte Carlo tuning plan generators whereby a large number of frequency patterns are attempted to sample the solution space. Other algorithms, such as algorithms for collision avoidance, may cycle through different topologies to incrementally shift qubit frequencies by parameterized amounts to find a collision-free (or collision-reduced) number of qubits in the chosen assessment topology until convergence or the greatest number of interconnected collision-free qubits within a computational time limit. Static optimizers using Monte Carlo tuning or simulated annealing might also be used.

Tuning success or completion of a junction may be determined by the proximity of a junction resistance to its target value. For example, a junction may be deemed ‘complete’ when the current junction resistance is measured to be within an acceptance threshold (e.g., 0.3%) of the target resistance. That is, if a target resistance is, for example, 10K Ohms, an acceptable success band may be defined to be +/−30 Ohms, or equivalently, a range from 9970 Ohms to 10030 Ohms. It is to be noted that the term ‘current junction resistance’ as used herein is meant to denote a junction resistance measured in the sense of occurring in or existing at a present time, or a most recently measured junction resistance.

A specific quantum computing-based device (e.g., a singulated die intended as a distinct quantum processor chip) may be deemed complete when all junctions are tuned satisfactorily (e.g., within 0.3%) of target resistances, and statistical yield models indicate that the expected likelihood of collisions or probability of zero-collision yield lies below an acceptance threshold. The overall quality of tuning, for example, may be assessed by observing a smooth and monotonic progression towards target resistances, starting from initial resistances. Note that it is also possible, for example, that upon a certain number of annealing rounds of LASIQ tuning for a given plan, that the yield rate will never be acceptable for the given plan. In a typical case, a maximum of 10 annealing rounds (for example) are therefore allowed for a given plan, as it has been typically and empirically the case that a larger number of iterations would indicate an inability of the tuning to converge to the desired target frequency plans. If the qubits do not reach target within this number of annealing rounds, the plan is deemed to be unapproachable and a new tuning plan is generated. In this case, the flow may also progress to block 3017, and a new plan is generated in block 3003. The number of acceptable annealing rounds may also be determined heuristically, based on the rate of progression towards targets as may be determined from historical tuning progressions, and/or calibration tuning rates on trial junctions.

Yield can be understood to include at least two principal elements. The first is tuning yield, which is a measure of the precision and/or accuracy of laser tuning of the Josephson junctions. The second is functional yield, which is a measure of the number of collisions of the tuned multi-qubit lattice, zero-collision probability, gate error yield (i.e., average gate error and gate fidelity), and the like. In general, the process of screening, which involves generating a tuning plan and assessing the quality of the tuning plan, relies on the assumption of perfect tuning yield. That is, all qubits successfully attain their targets after laser annealing. However, imperfect tuning yield will impact functional yield in the sense that qubits are no longer able to attain their target frequencies in all cases, which may impact the assessment of collisions, zero-collision probability, gate errors and the like.

It will accordingly be appreciated that one or more embodiments advantageously improve tuning precision in an adaptive tuning process, by which tuning imperfections may be compensated by determining alternate frequency constraints such that a new or modified tuning plan may be generated based on these alternate frequency constraints, and therefore increase the overall tuning precision and success rate.

In one or more embodiments, all structures are made of superconducting materials on a dielectric substrate and all structures contain Josephson junctions whose tunnel-barrier is susceptible to tuning by laser-annealing. Structures may include qubits of various kinds, or SQUIDs (superconducting quantum interference devices), or single Josephson junctions, or other combinations of Josephson junctions, capacitors and inductors. They may be galvanically, inductively, or capacitively linked with neighboring structures on-chip. A qubit chip may additionally incorporate functional structures which are not qubits but which contain Josephson junctions that may be of different design and construction as compared to the qubits. A modular quantum processor design may further incorporate quantum coupling structures whose Josephson junctions are of different design or construction as compared to the Josephson junctions in the qubits and other functional structures. The several types of Josephson junctions typically undergo calibration to determine their response to laser-power and exposure time. These separate calibrations determine the tuning range specific to each type of qubit or other structure.

The quantum lattices can include, for example, a data structure defining position, connectivity and type of element (e.g., qubit, SQUID, etc.), which is then utilized to measure and frequency tune the physical quantum processor via the LASIQ (or other) tuning process. Decision blocks can be comparison statements in a high-level programming language. Generally, for any elements or steps not described in great detail, the same can be implemented by the skilled artisan by adapting known techniques implemented in software, given the teachings herein.

### Recapitulation

Given the discussion thus far, it will be appreciated that, in general terms, an exemplary method (which can be carried out with a computerized frequency plan generator), according to an aspect of the invention, includes the step of, for each node (e.g., individual qubit) in a quantum lattice (see steps 1403-1409): determining a list of possible frequencies subject to at least one of nearest neighbor and next nearest neighbor collision constraints (e.g., that are already assigned); and assigning a highest possible frequency (f₀₁). A further step includes applying a collision cleaning routine to the quantum lattice with the assigned frequencies until at least one of a condition where there are no remaining collisions and a condition where collision count ceases to improve (see steps 1411-1417) and applying a frequency perturbation routine to the collision-cleaned quantum lattice to move apart at least one of a high-risk nearest neighbor collision and a high-risk next nearest neighbor collision (see step 1423).

Note, “high-risk” is not indefinite or merely relative because, given the teachings herein, the skilled artisan can identify a highest risk NN or NNN pair as described and disclosed. In an exemplary embodiment, we may utilize qubit pair or triplet detuning to rank the risk of collision for a particular collision type, based on the margin from the particular collision bound. In this way, for each collision type, it is possible to rank each set of qubit pair or triplets in the lattice in terms of their ‘distance’ from a collision (for a given collision type), and selectively perturb the highest-ranking qubit pair or triplet, based on the greatest contributing collision type. In other embodiments, a statistical analysis may be performed to rank the highest contributing collision pair or triplet. In general, any method of ranking qubit pairs or triplets according to their collision risk for each collision type may be used without impacting the overall structure of the perturbation routine. This method of perturbing qubits in rank-order of collision risk is an optimal method to mitigate collisions and improve gate-fidelity of quantum operations, while minimizing the number of perturbing steps needed to achieve a quantum processor that meets yield acceptance criteria (i.e., total collisions or median gate-fidelity).

Optionally, tuning minimization can be carried out. Thus, one or more embodiments further include, subsequent to application of the collision cleaning routine, and prior to the application of the frequency perturbation routine, carrying out a tuning minimization routine on the quantum lattice to minimize a required tuning distance.

Referring to FIG. 19, in one or more embodiments, the nodes are individual qubits, and the tuning minimization routine includes: ranking each qubit in the quantum lattice in order of tuning distance to obtain a ranked list; for each given qubit in the ranked list, beginning with a top ranked qubit, iteratively assigning a highest frequency level to the given qubit that is possible to achieve without introducing additional collisions (i.e., any one or more additional collision(s)), and removing the qubit from the ranked list, to obtain a minimum frequency assignment.

Referring to FIG. 18, in one or more embodiments, the collision cleaning routine includes listing all collision pairs (i.e., of qubits) for the quantum lattice for a plurality of user-defined collision types; and for each collision pair in the list of collision pairs, beginning with a top collision pair: listing possible collision-free frequency levels; assigning a highest viable frequency that reduces collision count; and removing the corresponding collision pair from the list of collision pairs. Optionally, half-level spacing or fractional level spacing may be utilized to allow frequency levels in the case where no viable existing frequency levels are available.

Referring now to FIG. 20, recall that, in one or more embodiments, the frequency perturbation routine perturbs the frequency pairs in a fixed-level plan (the deterministic part) to minimize the probability of collisions in the yield analysis. Thus, in one or more embodiments, the frequency perturbation routine includes, for a predetermined number of iterations: performing a Monte Carlo collision analysis on the quantum lattice to identify a most significant collision type; for the identified most significant collision type, identifying at least one of a highest risk nearest neighbor pair and a highest risk next nearest neighbor pair based on a corresponding frequency difference; and perturbing the identified at least one of a highest risk nearest neighbor pair and a highest risk next nearest neighbor pair by a predetermined incremental frequency subject to a corresponding qubit frequency tuning range.

Referring to FIG. 13, one or more embodiments further include carrying out tuning plan initialization prior to the determining and assigning steps, by (as per step 1301) determining the quantum lattice and an adjacency matrix based on a template file, such that lattice size, geometry, and connectivity are determined; specifying: tuning parameters, which determine how the frequencies are to be assigned, and frequency predictions based on junction resistances; and specifying collision parameters providing collision types and bounds for the collisions.

Referring now to the lattice stepping aspects of FIGS. 16 and 17, in some instances, the determining and assigning steps for each node in the quantum lattice are carried out in accordance with a recursive lattice stepping routine that enhances continuity of a stepping path through the quantum lattice.

As noted, and referring, for example, to FIG. 29, applications of the invention can be generalized to a multi-qubit chip with flux-tunable elements (e.g., tunable couplers) so that the nodes in the quantum lattice include qubits and at least one tunable element other than a qubit. Such applications further include defining lattice characteristics, including at least the collision constraints, which take into account operating characteristics of both the qubits and the at least one tunable element other than a qubit.

As also noted, and referring, for example, to FIGS. 26-28, applications of the invention can be generalized to modular devices. Such applications further include, for each chip of a plurality of available chips to be populated into a modular device, repeating the determining, assigning, collision cleaning, and frequency perturbation steps to obtain a frequency plan for each chip of the plurality of available chips (generally, perturbation to functional qubits and quantum-logic structures, and to quantum coupling structures). Further steps include, based on the frequency plans for each chip of the plurality of available chips, ranking the plurality of available chips based on yield; assigning a top-ranked one of the chips to the modular device; and, iteratively, until the modular device is completely populated with chips, for each remaining chip of the plurality of available chips, finding a highest-ranked neighbor candidate compatible with the top-ranked one of the chips and assigning the highest-ranked neighbor candidate to the modular device. (as noted, perturbation could be carried out here to at least the coupling structures).

One or more embodiments include carrying out or otherwise facilitating tuning physical qubits in accordance with a frequency tuning plan based on the quantum lattice with the frequency perturbation routine applied. For example, the tuning includes LASIQ (Laser Annealing of Stochastically Impaired Qubits) tuning.

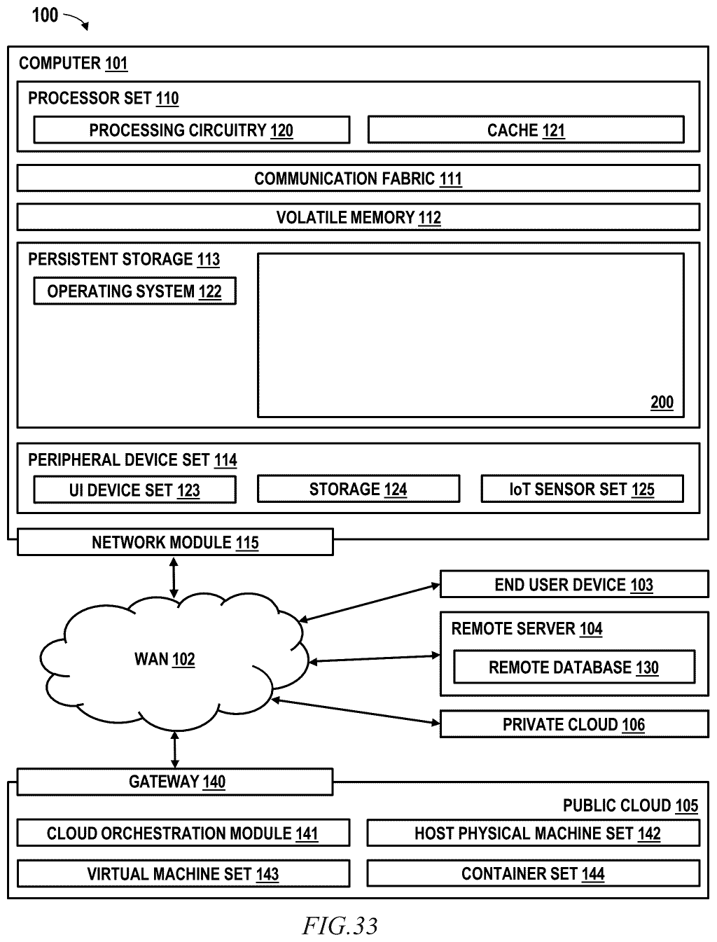

In another aspect (refer, e.g., to discussion of FIG. 33), a computer program product includes a computer readable storage medium having program instructions embodied therewith. The program instructions are executable by a processor such as 110 to cause the processor to perform any one, some, or all of the method steps herein.

The skilled artisan will appreciate that LASIQ tuning is a physical process, wherein a computer-controlled machine is making physical changes to the Josephson junction. When complete, the end result is a quantum computing device configured and tuned in accordance with techniques disclosed herein, which can be deployed and can carry out quantum calculations. The way in which yield is characterized advantageously ties into usability-good yield metrics are a direct measure of the usability of the quantum processor for quantum computations. Thus, the step of facilitating tuning physical qubits in accordance with a frequency tuning plan based on the quantum lattice with the frequency perturbation routine applied can include sending instructions to a LASIQ machine to tune a chip in accordance with the tuning plan. Such a tuned chip can then be deployed and used for computing. As noted below, end user device 103 could also include all or part (e.g., a controller) of a LASIQ tuning machine (controller, laser, mounting stage to hold chips, etc.), and such a machine could be coupled to computer 101 by WAN 102 or other network (e.g., local area network (WAN), wireless connection, direct cable connection, etc.). The skilled artisan will be familiar with LASIQ tuning machines per se, and, given the teachings herein, can utilize a LASIQ tuning machine to implement a tuning plan in accordance with aspects of the invention.

Refer now to FIG. 33, it being understood that techniques disclosed herein include, for example, computer-aided design of a quantum computer, wherein the aspects of the design process can be implemented on any kind of computer, quantum or conventional.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Refer now to FIG. 33. Note that end user device 103 discussed below could also include all or part (e.g., a controller) of a LASIQ tuning machine (controller, laser, mounting stage to hold chips, etc.), and such a machine could be coupled to computer 101 by WAN 102 or other network (e.g., local area network (WAN), wireless connection, direct cable connection, etc.).

Computing environment 100 contains an example of an environment for the execution of at least some of the computer code involved in performing the inventive methods, as seen at 200 (e.g., code that implements a frequency plan generator for multi-qubit processors). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 33. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 33 depicts a computer system that may be useful in implementing one or more aspects and/or elements of the invention

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising, with a computerized frequency plan generator:
for each node in a quantum lattice:
determining a list of possible frequencies subject to at least one of nearest neighbor and next nearest neighbor collision constraints; and
assigning a highest possible frequency;
applying a collision cleaning routine to the quantum lattice with the assigned frequencies until at least one of a condition where there are no remaining collisions and a condition where collision count ceases to improve; and
applying a frequency perturbation routine to the collision-cleaned quantum lattice to move apart at least one of a high-risk nearest neighbor collision and a high risk next nearest neighbor collision.

2. The method of claim 1, further comprising, subsequent to application of the collision cleaning routine, and prior to the application of the frequency perturbation routine, carrying out a tuning minimization routine on the quantum lattice to minimize a required tuning distance.

3. The method of claim 2, wherein the nodes comprise individual qubits, and wherein the tuning minimization routine comprises:
ranking each qubit in the quantum lattice in order of tuning distance to obtain a ranked list;
for each given qubit in the ranked list, beginning with a top ranked qubit, iteratively assigning a highest frequency level to the given qubit that is possible to achieve without introducing additional collisions, and removing the qubit from the ranked list, to obtain a minimum frequency assignment.

4. The method of claim 1, wherein the collision cleaning routine comprises:
listing all collision pairs for the quantum lattice for a plurality of user-defined collision types;
for each collision pair in the list of collision pairs, beginning with a top collision pair:
listing possible collision-free frequency levels;
assigning a highest viable frequency that reduces collision count; and
removing the corresponding collision pair from the list of collision pairs.

5. The method of claim 1, wherein the frequency perturbation routine comprises, for a predetermined number of iterations:
performing a Monte Carlo collision analysis on the quantum lattice to identify a most significant collision type;
for the identified most significant collision type, identifying at least one of a highest risk nearest neighbor pair and a highest risk next nearest neighbor pair based on a corresponding frequency difference; and
perturbing the identified at least one of a highest risk nearest neighbor pair and a highest risk next nearest neighbor pair by a predetermined incremental frequency subject to a corresponding qubit frequency tuning range.

6. The method of claim 1, further comprising carrying out tuning plan initialization prior to the determining and assigning steps, by
determining the quantum lattice and an adjacency matrix based on a template file, such that lattice size, geometry, and connectivity are determined;
specifying:
tuning parameters, which determine how the frequencies are to be assigned, and
frequency predictions based on junction resistances; and
specifying collision parameters providing collision types and bounds for the collisions.

7. The method of claim 1, wherein the determining and assigning steps for each node in the quantum lattice are carried out in accordance with a recursive lattice stepping routine that enhances continuity of a stepping path through the quantum lattice.

8. The method of claim 1, wherein the nodes in the quantum lattice include qubits and at least one tunable element other than a qubit, further comprising defining lattice characteristics, including at least the collision constraints, which take into account operating characteristics of both the qubits and the at least one tunable element other than a qubit.

9. The method of claim 1, further comprising:
for each chip of a plurality of available chips to be populated into a modular device, repeating the determining, assigning, collision cleaning, and frequency perturbation steps to obtain a frequency plan for each chip of the plurality of available chips;
based on the frequency plans for each chip of the plurality of available chips, ranking the plurality of available chips based on yield;
assigning a top-ranked one of the chips to the modular device; and
iteratively, until the modular device is completely populated with chips, for each remaining chip of the plurality of available chips, finding a highest-ranked neighbor candidate compatible with the top-ranked one of the chips and assigning the highest-ranked neighbor candidate to the modular device.

10. The method of claim 1, further comprising facilitating tuning physical qubits in accordance with a frequency tuning plan based on the quantum lattice with the frequency perturbation routine applied.

11. The method of claim 10, wherein the tuning comprises LASIQ (Laser Annealing of Stochastically Impaired Qubits) tuning.

12. A computer program product comprising a computer readable storage medium having program instructions embodied therewith, the program instructions executable by a processor to cause the processor to perform a method comprising:
for each node in a quantum lattice:
determining a list of possible frequencies subject to at least one of nearest neighbor and next nearest neighbor collision constraints; and
assigning a highest possible frequency;
applying a collision cleaning routine to the quantum lattice with the assigned frequencies until at least one of a condition where there are no remaining collisions and a condition where collision count ceases to improve; and
applying a frequency perturbation routine to the collision-cleaned quantum lattice to move apart at least one of a high-risk nearest neighbor collision and a high risk next nearest neighbor collision.

13. A system comprising:
a memory; and
at least one processor, coupled to said memory, and operative to:
for each node in a quantum lattice:
determine a list of possible frequencies subject to at least one of nearest neighbor and next nearest neighbor collision constraints; and
assign a highest possible frequency;
apply a collision cleaning routine to the quantum lattice with the assigned frequencies until at least one of a condition where there are no remaining collisions and a condition where collision count ceases to improve; and
apply a frequency perturbation routine to the collision-cleaned quantum lattice to move apart at least one of a high-risk nearest neighbor collision and a high risk next nearest neighbor collision.

14. The system of claim 13, wherein the at least one processor is further operative to, subsequent to application of the collision cleaning routine, and prior to the application of the frequency perturbation routine, carry out a tuning minimization routine on the quantum lattice to minimize a required tuning distance.

15. The system of claim 14, wherein the nodes comprise individual qubits, and wherein the tuning minimization routine comprises:
ranking each qubit in the quantum lattice in order of tuning distance to obtain a ranked list;
for each given qubit in the ranked list, beginning with a top ranked qubit, iteratively assigning a highest frequency level to the given qubit that is possible to achieve without introducing additional collisions, and removing the qubit from the ranked list, to obtain a minimum frequency assignment.

16. The system of claim 13, wherein the collision cleaning routine comprises:
listing all collision pairs for the quantum lattice for a plurality of user-defined collision types;
for each collision pair in the list of collision pairs, beginning with a top collision pair:
listing possible collision-free frequency levels;
assigning a highest viable frequency that reduces collision count; and
removing the corresponding collision pair from the list of collision pairs.

17. The system of claim 13, wherein the frequency perturbation routine comprises, for a predetermined number of iterations:
performing a Monte Carlo collision analysis on the quantum lattice to identify a most significant collision type;
for the identified most significant collision type, identifying at least one of a highest risk nearest neighbor pair and a highest risk next nearest neighbor pair based on a corresponding frequency difference; and
perturbing the identified at least one of a highest risk nearest neighbor pair and a highest risk next nearest neighbor pair by a predetermined incremental frequency subject to a corresponding qubit frequency tuning range.

18. The system of claim 13, wherein the determining and assigning steps for each node in the quantum lattice are carried out in accordance with a recursive lattice stepping routine that enhances continuity of a stepping path through the quantum lattice.

19. The system of claim 13, wherein the nodes in the quantum lattice include qubits and at least one tunable element other than a qubit, and wherein the at least one processor is further operative to define lattice characteristics, including at least the collision constraints, which take into account operating characteristics of both the qubits and the at least one tunable element other than a qubit.

20. The system of claim 13, wherein the at least one processor is further operative to facilitate tuning physical qubits in accordance with a frequency tuning plan based on the quantum lattice with the frequency perturbation routine applied.
